(19) United States
(12) Patent Application Publication
(10) Pub. No.: US 2024/0044656 A1
(43) Pub. Date: Feb. 8, 2024

(54) SEARCHING FOR STOPS IN MULTISTOP ROUTES

(71) Applicant: Apple Inc., Cupertino, CA (US)

(72) Inventors: Francimar C. SCHMITT, Santa Clara, CA (US); Nick PROVENZANO, San Francisco, CA (US); Brian J. ANDRICH, San Francisco, CA (US); Woon Yung CHOI, San Francisco, CA (US); Darious L. ALLEN, San Francisco, CA (US); Kirill NEGODA, San Jose, CA (US); William A. VIGLAKIS, San Francisco, CA (US)

(21) Appl. No.: 18/329,527

(22) Filed: Jun. 5, 2023

Related U.S. Application Data
(60) Provisional application No. 63/365,880, filed on Jun. 5, 2022.

(51) Int. Cl. G01C 21/34; G01C 21/36

(52) U.S. Cl. CPC G01C 21/343; G01C 21/3664; G01C 21/367

(57) ABSTRACT

In some embodiments, an electronic device detects a first user input corresponding to a request to search for an additional destination in a multi stop route, and the location on which the search is centered depends on whether or not navigation along the route is ongoing.

### CROSS REFERENCE TO RELATED APPLICATION

This application claims the benefit of U.S. Provisional Application No. 63/365,880, filed Jun. 5, 2022, the entire disclosure of which is herein incorporated by reference for all purposes.

### FIELD OF THE DISCLOSURE

This relates generally to user interfaces associated with searching for stops in multiple stop routes.

### BACKGROUND OF THE DISCLOSURE

User interaction with electronic devices has increased significantly in recent years. These devices can be devices such as computers, tablet computers, televisions, multimedia devices, mobile devices, and the like. In some circumstances, users wish to use devices to facilitate creation and/or presentation of multi-stop routes.

### SUMMARY OF THE DISCLOSURE

Some embodiments described in this disclosure are directed to one or more electronic devices that detect, via the one or more input devices, a first user input corresponding to a request to add a first destination to a route. Some embodiments described in this disclosure are directed to one or more electronic devices that detect, via the one or more input devices, a second user input corresponding to a request to search for a second destination to be added to the route. Some embodiments described in this disclosure are directed to one or more electronic devices that initiate the search for the second destination based on the second user input, wherein the search is centered on a geographic area that includes the first destination in the route. The full descriptions of the embodiments are provided in the Drawings and the Detailed Description, and it is understood that the Summary provided above does not limit the scope of the disclosure in any way.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIGS. 5I-5N provide a set of sample tactile output patterns that may be used, either individually or in combination, either as is or through one or more transformations (e.g., modulation, amplification, truncation, etc.), to create suitable haptic feedback in various scenarios and for various purposes, such as those mentioned above and those described with respect to the user interfaces and methods discussed herein.

FIGS. 6A-6II illustrate exemplary ways of searching for stops in a multiple stop route in accordance with some embodiments of the disclosure.

FIG. 7 is a flow diagram illustrating a method 700 of searching for stops in a multiple stop route in accordance with some embodiments.

### DETAILED DESCRIPTION

The following description sets forth exemplary methods, parameters, and the like. It should be recognized, however, that such description is not intended as a limitation on the scope of the present disclosure but is instead provided as a description of exemplary embodiments.

There is a need for electronic devices to efficiently search for stops in multiple stop routes. Such techniques can reduce the cognitive burden on a user who uses such devices. Further, such techniques can reduce processor and battery power otherwise wasted on redundant user inputs.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad).

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

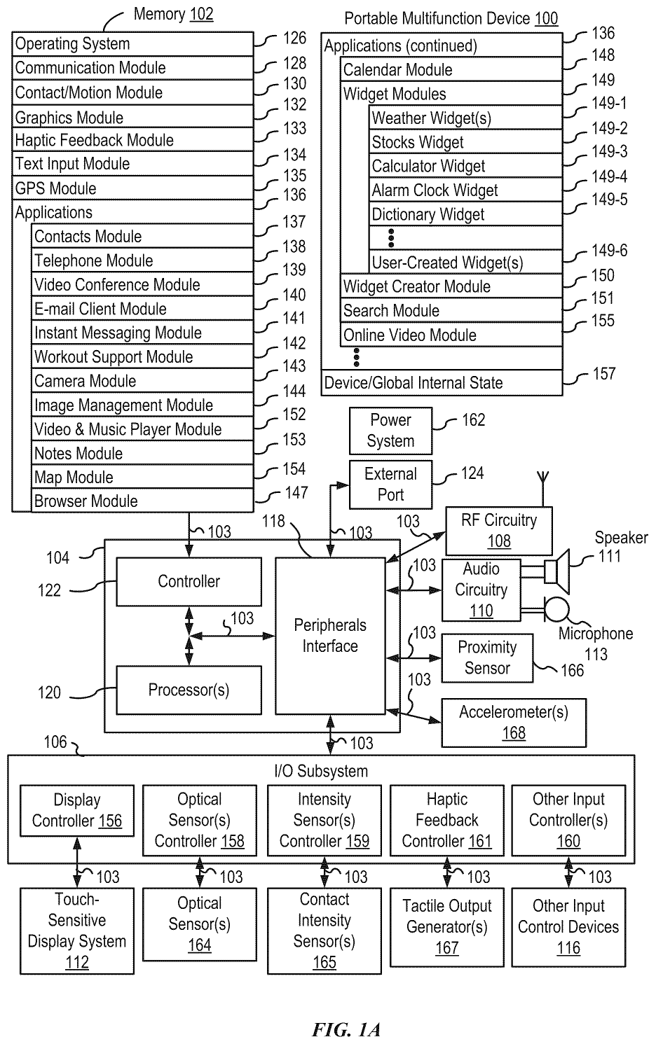

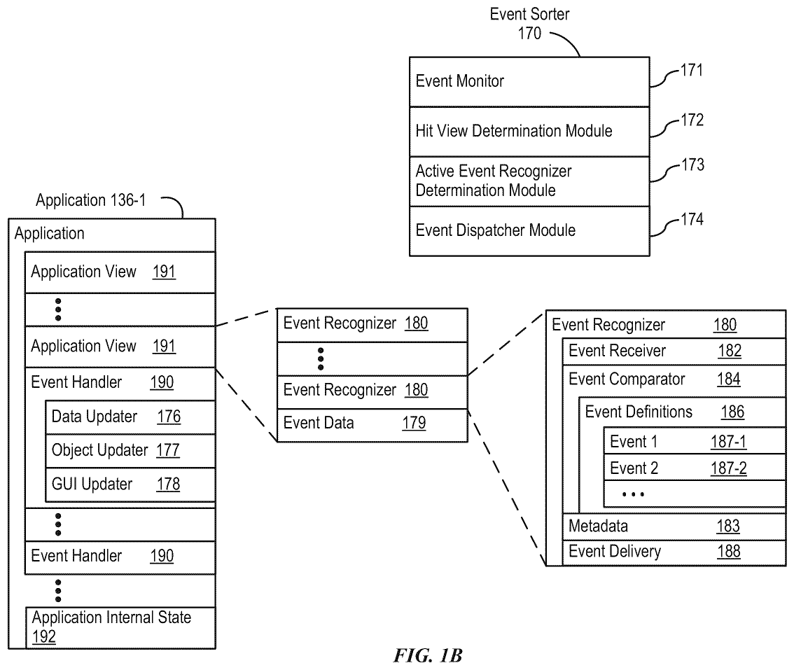

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

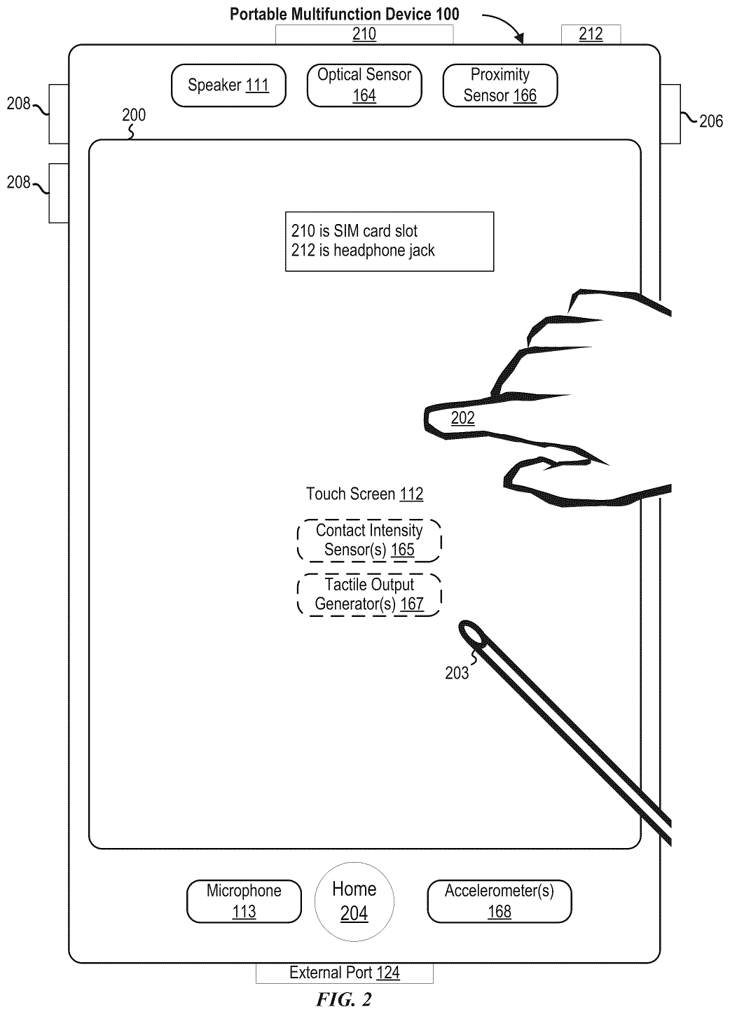

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

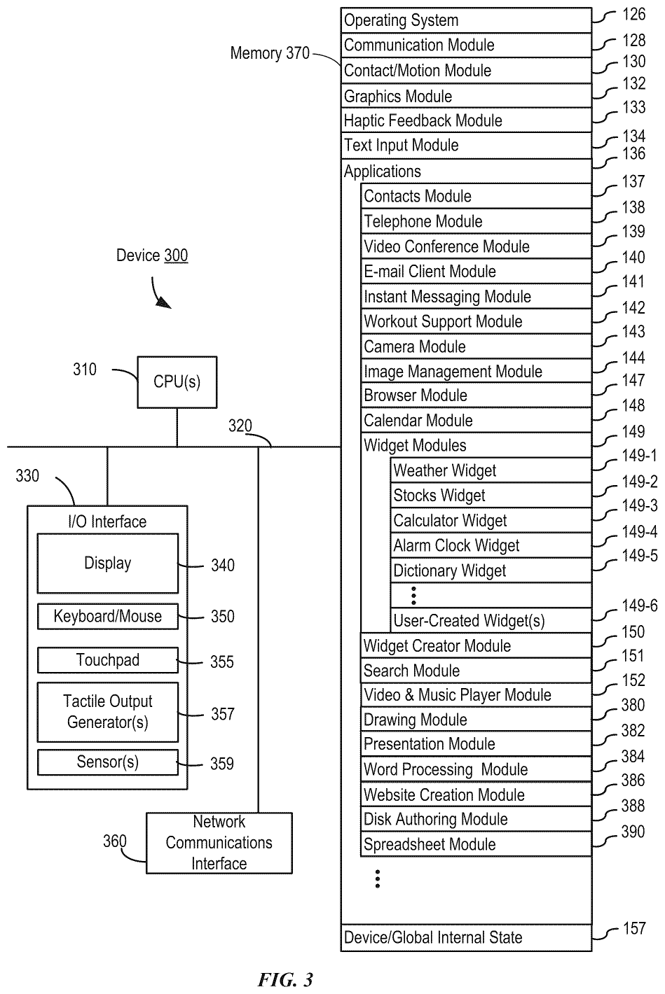

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo!Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or programs (e.g., sets of instructions) need not be implemented as separate software programs, procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

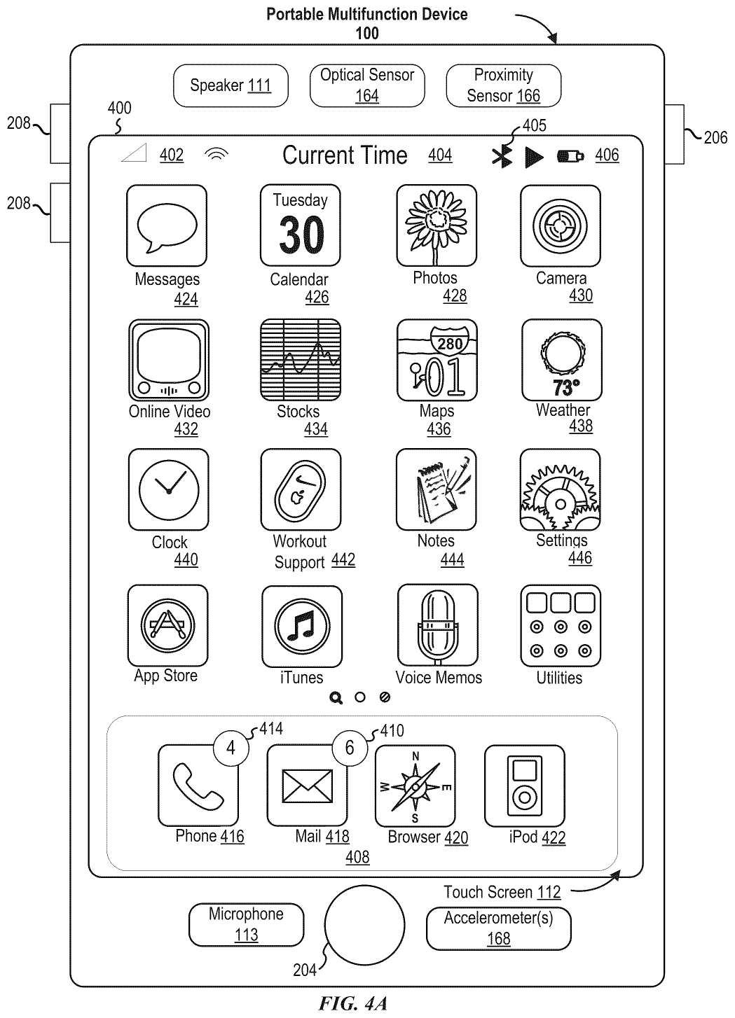

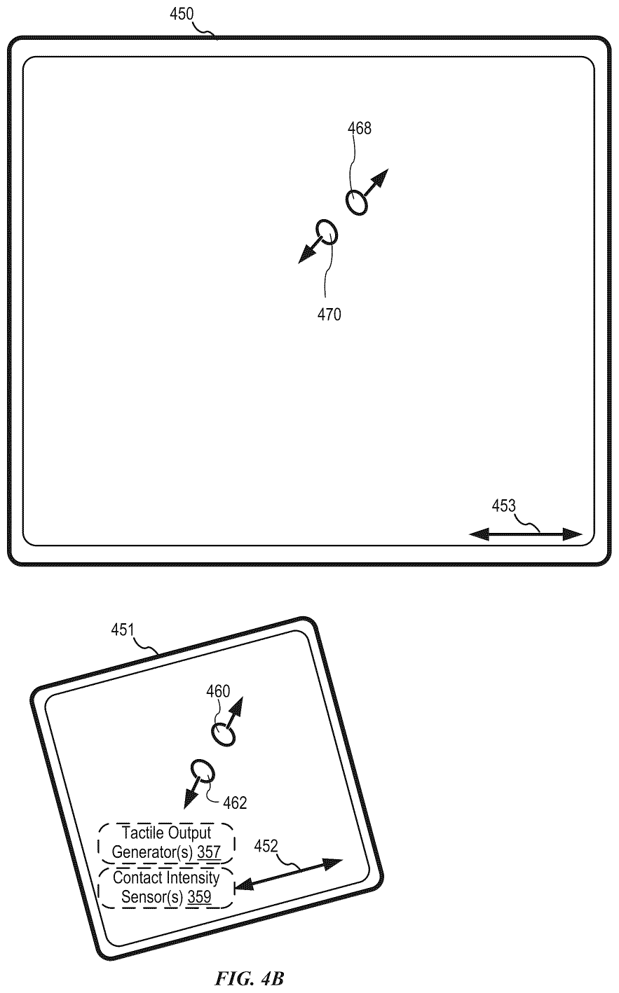

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

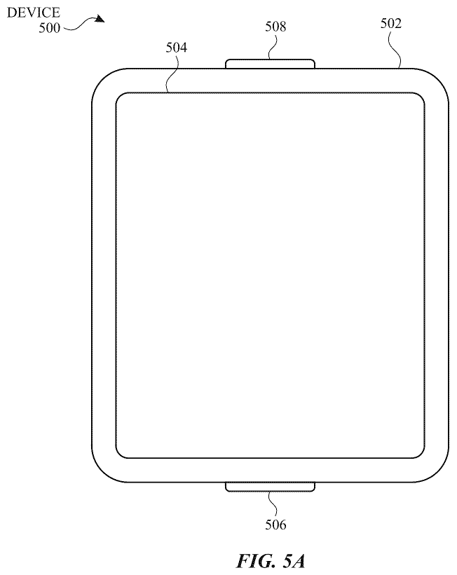

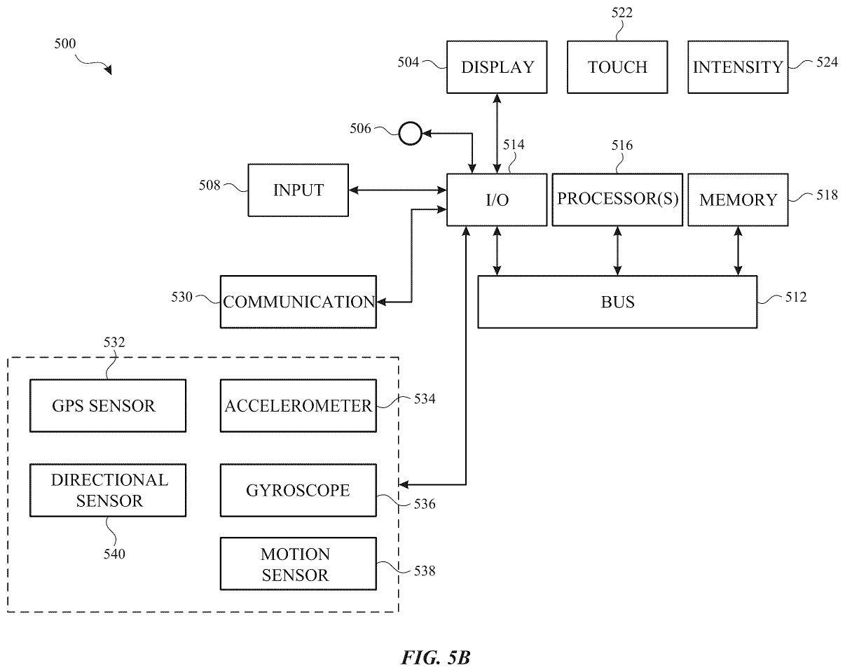

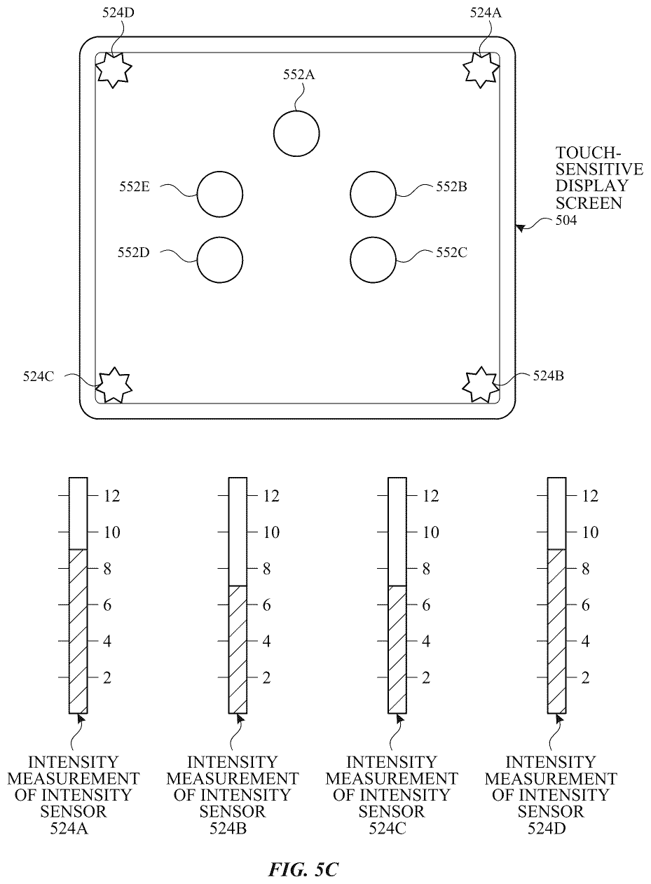

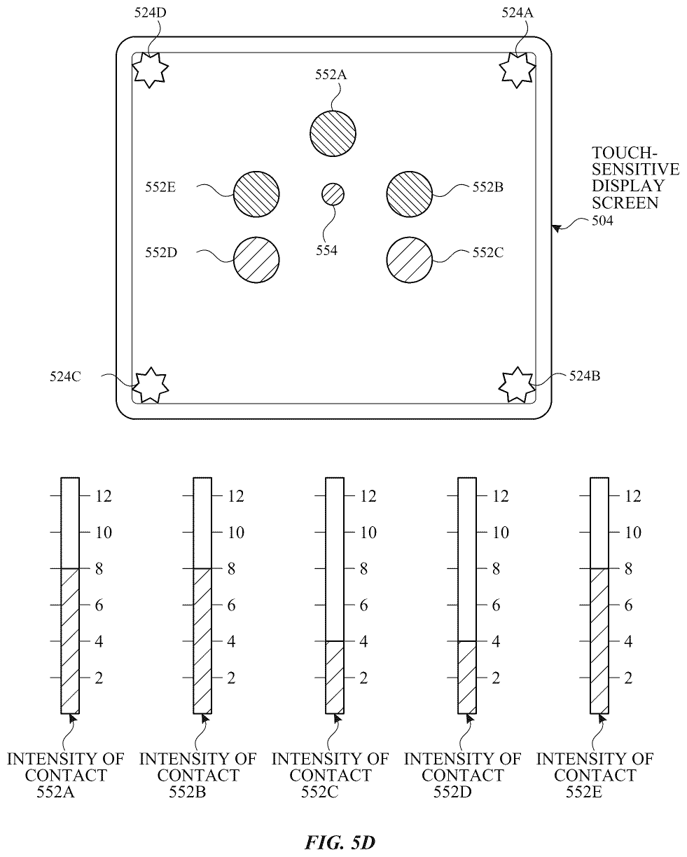

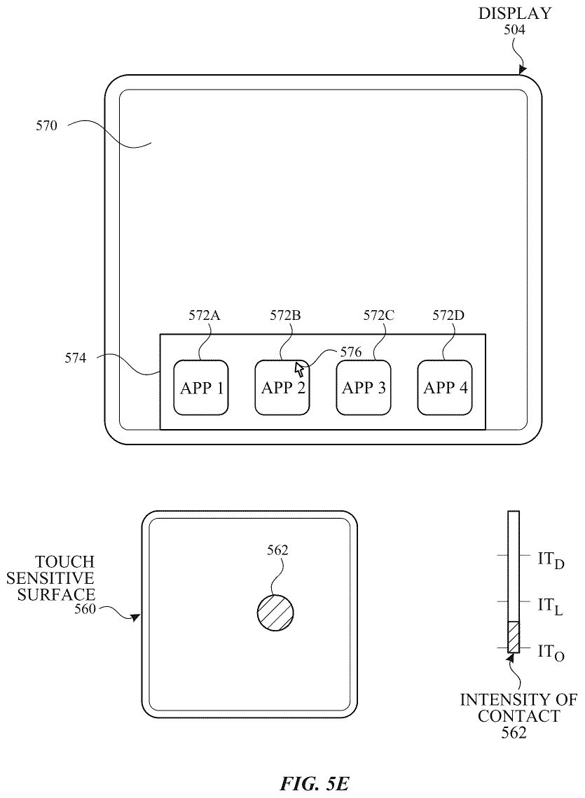

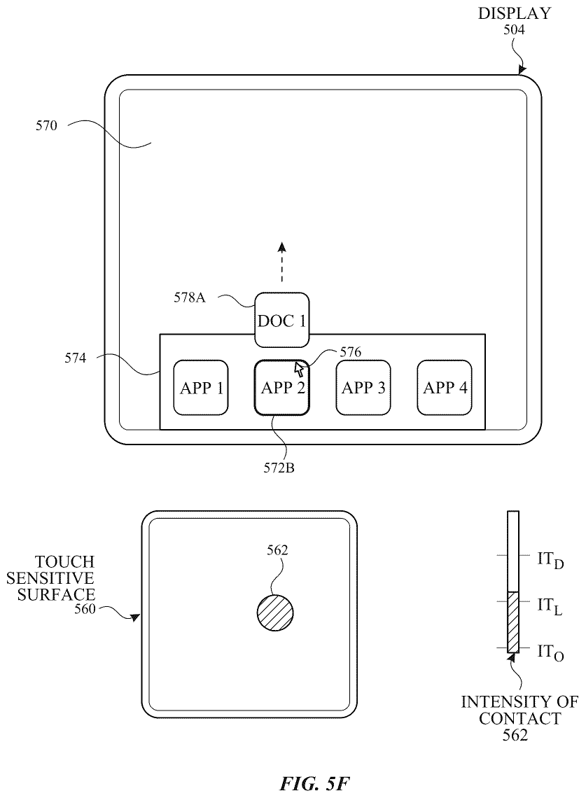

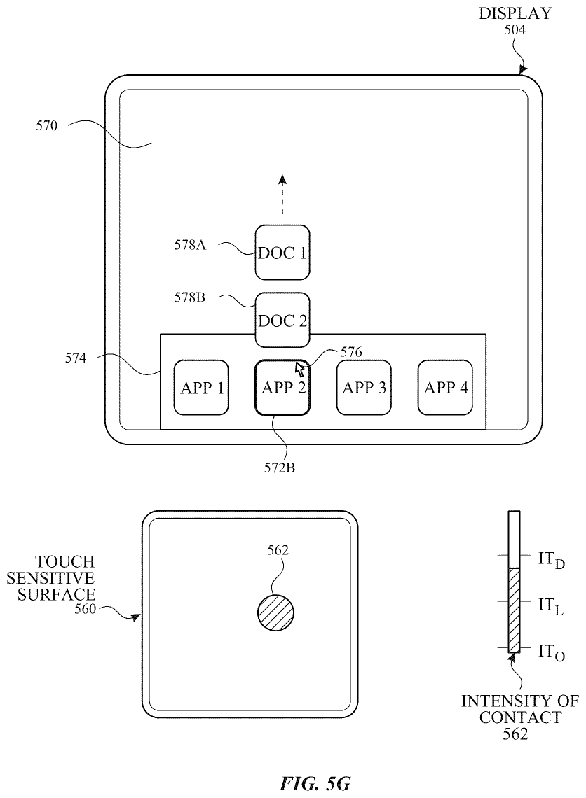

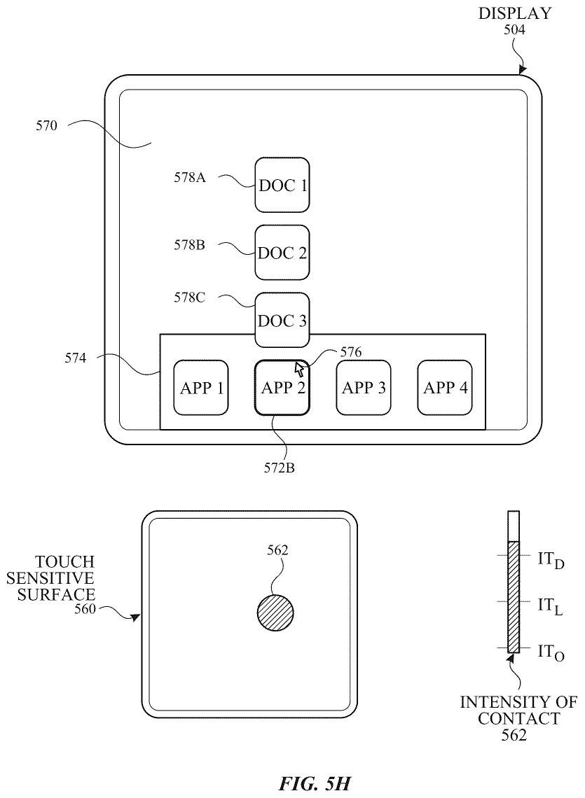

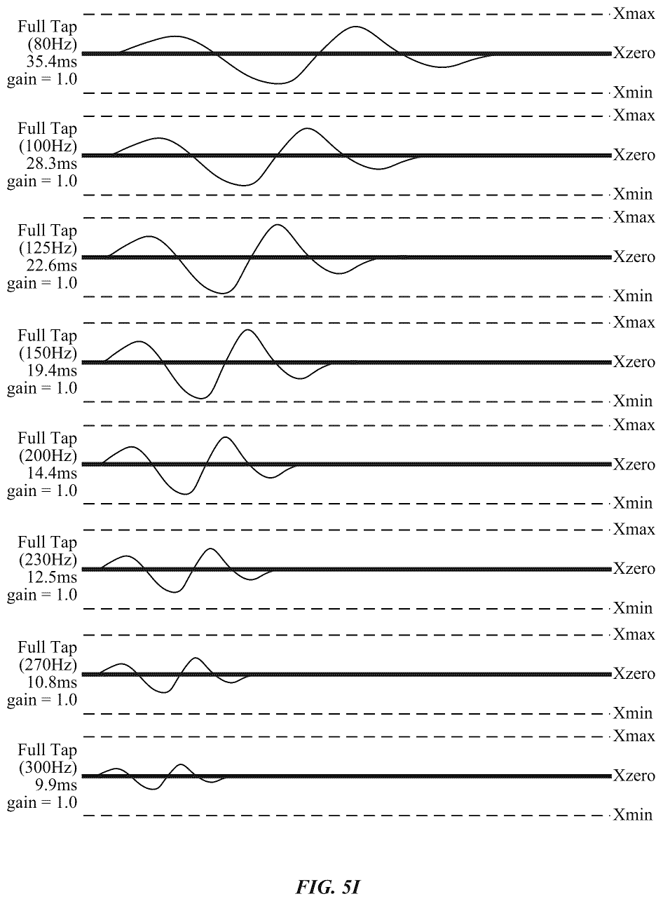

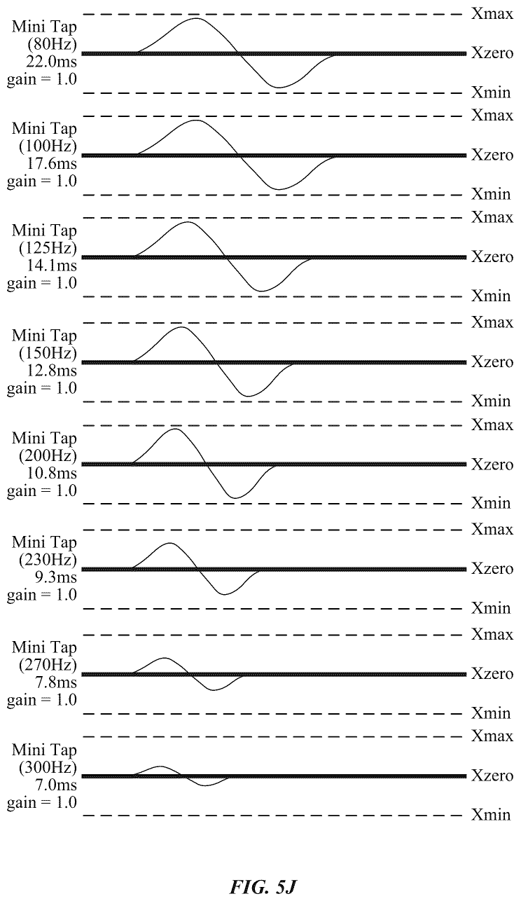

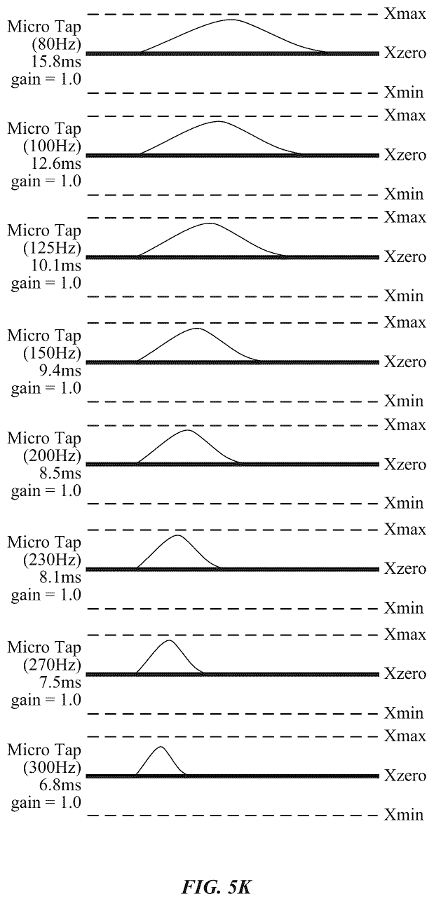

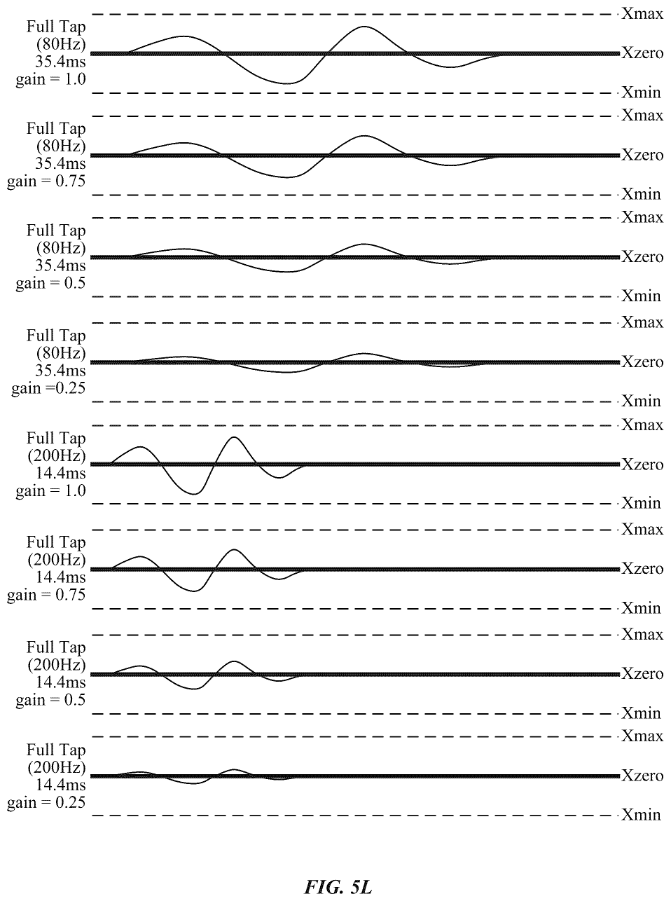

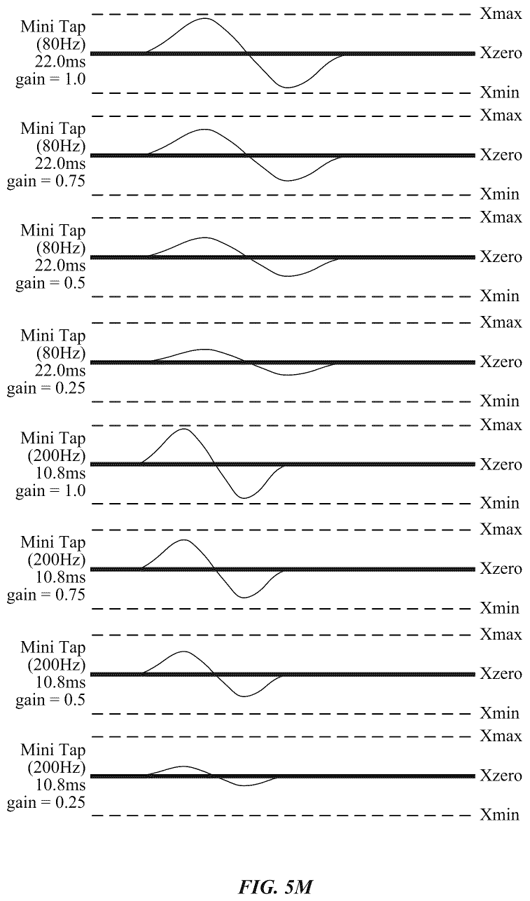

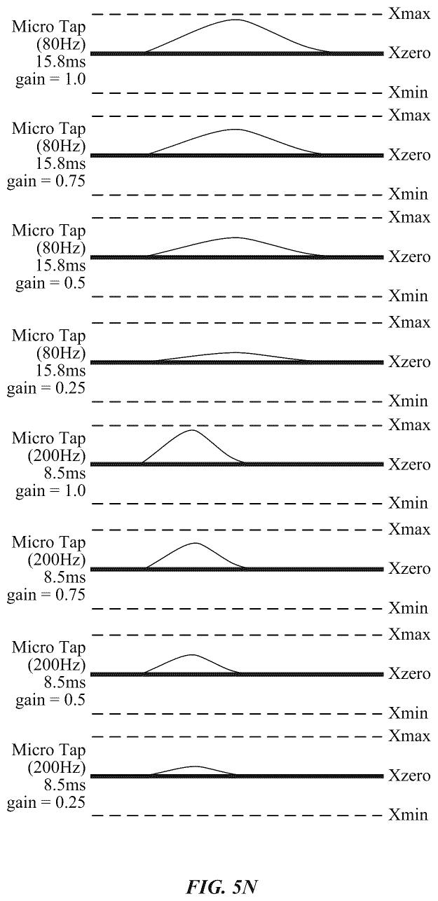

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

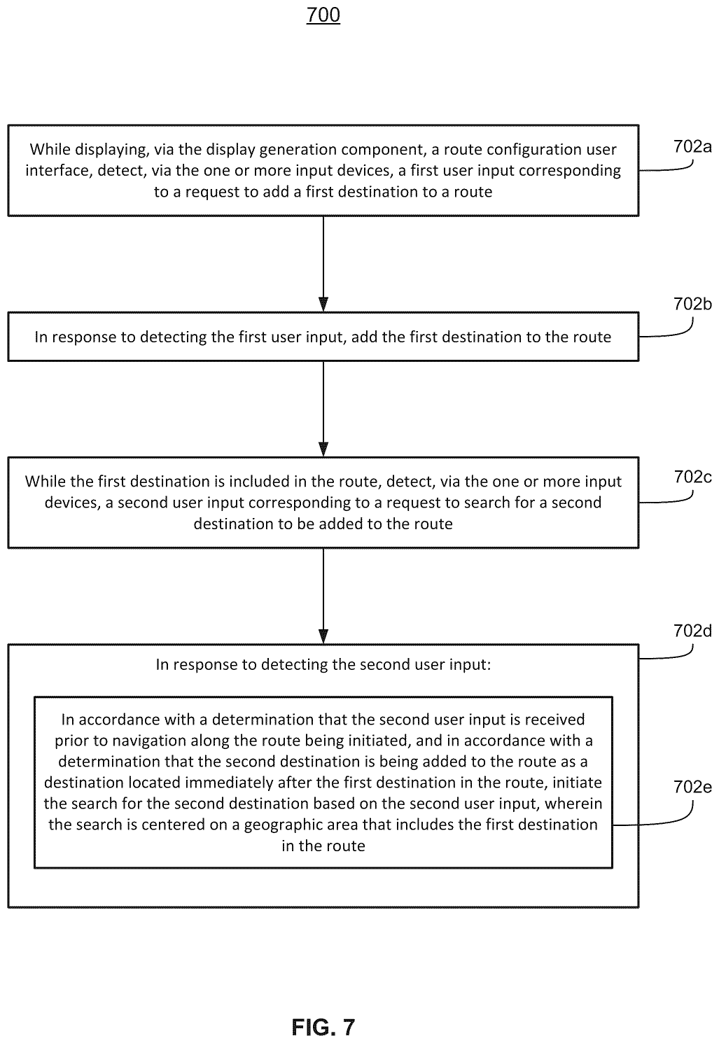

Memory 518 of personal electronic device 500 can include one or more non-transitory computer-readable storage mediums, for storing computer-executable instructions, which, when executed by one or more computer processors 516, for example, can cause the computer processors to perform the techniques described below, including process 700 (FIG. 7). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A·(Dj/ΣDi), where Dj is the distance of the respective contact j to the center of force, and ΣDi is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “IT_{L}”) in FIG. 5E, to an intensity above a deep press intensity threshold (e.g., “IT_{D}”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “IT_{D}”). Contact 562 is maintained on touch-sensitive surface 560. In response to the detection of the gesture, and in accordance with contact 562 having an intensity that goes above the deep press intensity threshold (e.g., “IT_{D}”) during the gesture, reduced-scale representations 578A-578C (e.g., thumbnails) of recently opened documents for App 2 are displayed, as shown in FIGS. 5F-5H. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “IT_{D}”). In some embodiments, the intensity, on which the progress of the animation is based, is the characteristic intensity of the contact. The operations described with reference to FIGS. 5E-5H can be performed using an electronic device similar or identical to device 100, 300, or 500.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

In some embodiments, electronic device 500 includes one or more tactile output generators, where the one or more tactile output generators generate different types of tactile output sequences, as described below in Table 1. In some embodiments, a particular type of tactile output sequence generated by the one or more tactile output generators of the device corresponds to a particular tactile output pattern. For example, a tactile output pattern specifies characteristics of a tactile output, such as the amplitude of the tactile output, the shape of a movement waveform of the tactile output, the frequency of the tactile output, and/or the duration of the tactile output. When tactile outputs with different tactile output patterns are generated by a device (e.g., via one or more tactile output generators that move a moveable mass to generate tactile outputs), the tactile outputs may invoke different haptic sensations in a user holding or touching the device. While the sensation of the user is based on the user's perception of the tactile output, most users will be able to identify changes in waveform, frequency, and amplitude of tactile outputs generated by the device.

More specifically, FIGS. 5I-5K provide a set of sample tactile output patterns that may be used, either individually or in combination, either as is or through one or more transformations (e.g., modulation, amplification, truncation, etc.), to create suitable haptic feedback in various scenarios and for various purposes, such as those mentioned above and those described with respect to the user interfaces and methods discussed herein. This example of a palette of tactile outputs shows how a set of three waveforms and eight frequencies can be used to produce an array of tactile output patterns. In addition to the tactile output patterns shown in these figures, each of these tactile output patterns is optionally adjusted in amplitude by changing a gain value for the tactile output pattern, as shown, for example for FullTap 80 Hz, FullTap 200 Hz, MiniTap 80 Hz, MiniTap 200 Hz, MicroTap 80 Hz, and MicroTap 200 Hz in FIGS. 5L-5N, which are each shown with variants having a gain of 1.0, 0.75, 0.5, and 0.25. As shown in FIGS. 5L-5N, changing the gain of a tactile output pattern changes the amplitude of the pattern without changing the frequency of the pattern or changing the shape of the waveform. In some embodiments, changing the frequency of a tactile output pattern also results in a lower amplitude as some tactile output generators are limited by how much force can be applied to the moveable mass and thus higher frequency movements of the mass are constrained to lower amplitudes to ensure that the acceleration needed to create the waveform does not require force outside of an operational force range of the tactile output generator (e.g., the peak amplitudes of the FullTap at 230 Hz, 270 Hz, and 300 Hz are lower than the amplitudes of the FullTap at 80 Hz, 100 Hz, 125 Nz, and 200 Hz).

FIGS. 5I-5N show tactile output patterns that have a particular waveform. The waveform of a tactile output pattern represents the pattern of physical displacements relative to a neutral position (e.g., Xzero) versus time that a moveable mass goes through to generate a tactile output with that tactile output pattern. For example, a first set of tactile output patterns shown in FIG. 5I (e.g., tactile output patterns of a “FullTap”) each have a waveform that includes an oscillation with two complete cycles (e.g., an oscillation that starts and ends in a neutral position and crosses the neutral position three times). A second set of tactile output patterns shown in FIG. 5J (e.g., tactile output patterns of a “MiniTap”) each have a waveform that includes an oscillation that includes one complete cycle (e.g., an oscillation that starts and ends in a neutral position and crosses the neutral position one time). A third set of tactile output patterns shown in FIG. 5K (e.g., tactile output patterns of a “MicroTap”) each have a waveform that includes an oscillation that include one half of a complete cycle (e.g., an oscillation that starts and ends in a neutral position and does not cross the neutral position). The waveform of a tactile output pattern also includes a start buffer and an end buffer that represent the gradual speeding up and slowing down of the moveable mass at the start and at the end of the tactile output. The example waveforms shown in FIGS. 5I-5N include Xmin and Xmax values which represent the maximum and minimum extent of movement of the moveable mass. For larger electronic devices with larger moveable masses, there may be larger or smaller minimum and maximum extents of movement of the mass. The examples shown in FIGS. 5I-5N describe movement of a mass in one dimension, however similar principles would also apply to movement of a moveable mass in two or three dimensions.

As shown in FIGS. 5I-5K, each tactile output pattern also has a corresponding characteristic frequency that affects the “pitch” of a haptic sensation that is felt by a user from a tactile output with that characteristic frequency. For a continuous tactile output, the characteristic frequency represents the number of cycles that are completed within a given period of time (e.g., cycles per second) by the moveable mass of the tactile output generator. For a discrete tactile output, a discrete output signal (e.g., with 0.5, 1, or 2 cycles) is generated, and the characteristic frequency value specifies how fast the moveable mass needs to move to generate a tactile output with that characteristic frequency. As shown in FIGS. 5I-5N, for each type of tactile output (e.g., as defined by a respective waveform, such as FullTap, MiniTap, or MicroTap), a higher frequency value corresponds to faster movement(s) by the moveable mass, and hence, in general, a shorter time to complete the tactile output (e.g., including the time to complete the required number of cycle(s) for the discrete tactile output, plus a start and an end buffer time). For example, a FullTap with a characteristic frequency of 80 Hz takes longer to complete than FullTap with a characteristic frequency of 100 Hz (e.g., 35.4 ms vs. 28.3 ms in FIG. 5I). In addition, for a given frequency, a tactile output with more cycles in its waveform at a respective frequency takes longer to complete than a tactile output with fewer cycles its waveform at the same respective frequency. For example, a FullTap at 150 Hz takes longer to complete than a MiniTap at 150 Hz (e.g., 19.4 ms vs. 12.8 ms), and a MiniTap at 150 Hz takes longer to complete than a MicroTap at 150 Hz (e.g., 12.8 ms vs. 9.4 ms). However, for tactile output patterns with different frequencies this rule may not apply (e.g., tactile outputs with more cycles but a higher frequency may take a shorter amount of time to complete than tactile outputs with fewer cycles but a lower frequency, and vice versa). For example, at 300 Hz, a FullTap takes as long as a MiniTap (e.g., 9.9 ms).

As shown in FIGS. 5I-5K, a tactile output pattern also has a characteristic amplitude that affects the amount of energy that is contained in a tactile signal, or a “strength” of a haptic sensation that may be felt by a user through a tactile output with that characteristic amplitude. In some embodiments, the characteristic amplitude of a tactile output pattern refers to an absolute or normalized value that represents the maximum displacement of the moveable mass from a neutral position when generating the tactile output. In some embodiments, the characteristic amplitude of a tactile output pattern is adjustable, e.g., by a fixed or dynamically determined gain factor (e.g., a value between 0 and 1), in accordance with various conditions (e.g., customized based on user interface contexts and behaviors) and/or preconfigured metrics (e.g., input-based metrics, and/or user-interface-based metrics). In some embodiments, an input-based metric (e.g., an intensity-change metric or an input-speed metric) measures a characteristic of an input (e.g., a rate of change of a characteristic intensity of a contact in a press input or a rate of movement of the contact across a touch-sensitive surface) during the input that triggers generation of a tactile output. In some embodiments, a user-interface-based metric (e.g., a speed-across-boundary metric) measures a characteristic of a user interface element (e.g., a speed of movement of the element across a hidden or visible boundary in a user interface) during the user interface change that triggers generation of the tactile output. In some embodiments, the characteristic amplitude of a tactile output pattern may be modulated by an “envelope” and the peaks of adjacent cycles may have different amplitudes, where one of the waveforms shown above is further modified by multiplication by an envelope parameter that changes over time (e.g., from 0 to 1) to gradually adjust amplitude of portions of the tactile output over time as the tactile output is being generated.

Although specific frequencies, amplitudes, and waveforms are represented in the sample tactile output patterns in FIGS. 5I-5K for illustrative purposes, tactile output patterns with other frequencies, amplitudes, and waveforms may be used for similar purposes. For example, waveforms that have between 0.5 to 4 cycles can be used. Other frequencies in the range of 60 Hz-400 Hz may be used as well. Table 1 below provides representative examples of tactile output/haptic feedback behaviors and configurations, and examples of their use with respect to the user interfaces for managing content-based tactile outputs that are illustrated and described herein.

TABLE 1

| | | Textural |
|---|---|---|
| Type of Tactile | | (continuous) or |
| Output Sequence | Waveform | Discrete |
| ″Major″ | MiniTap at 180 Hz | Discrete |
| ″Minor″ | MicroTap at 80 Hz | Textural |
| ″Major-reduced″ | MiniTap at 200 Hz | Discrete |
| ″Minor-Reduced″ | MicroTap at 200 Hz | Discrete |

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as portable multifunction device 100, device 300, or device 500.

### User Interfaces and Associated Processes

### Searching for Stops in Multiple Stop Routes

Users interact with electronic devices in many different manners. The embodiments described below provide ways in which an electronic device facilitates searching for additional stops in a multistop route. Enhancing interactions with a device reduces the amount of time needed by a user to perform operations, and thus reduces the power usage of the device and increases battery life for battery-powered devices. It is understood that people use devices. When a person uses a device, that person is optionally referred to as a user of the device.

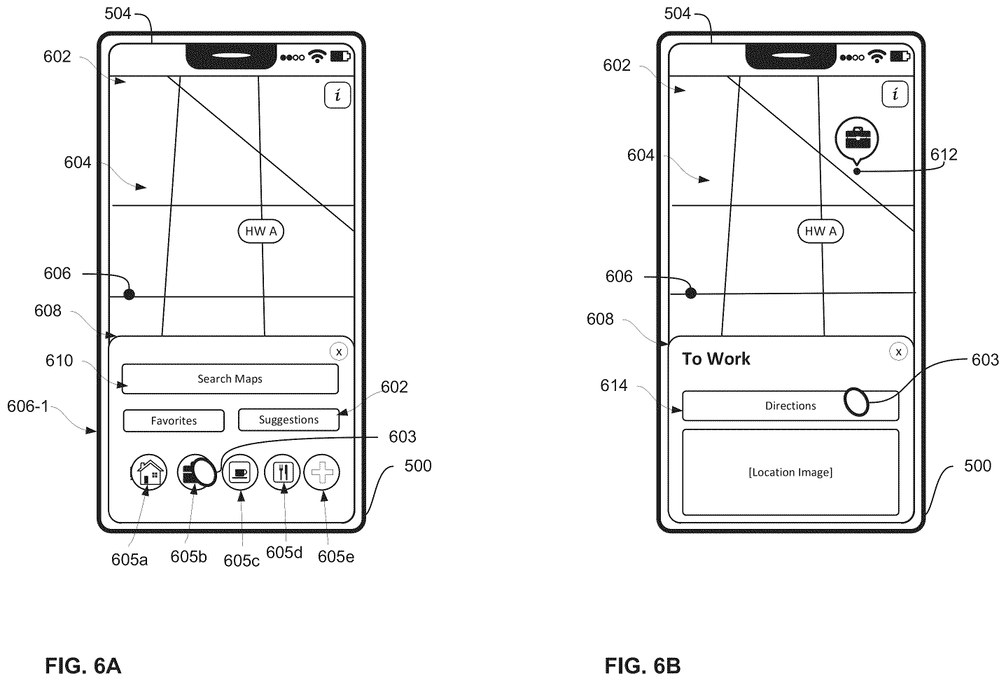

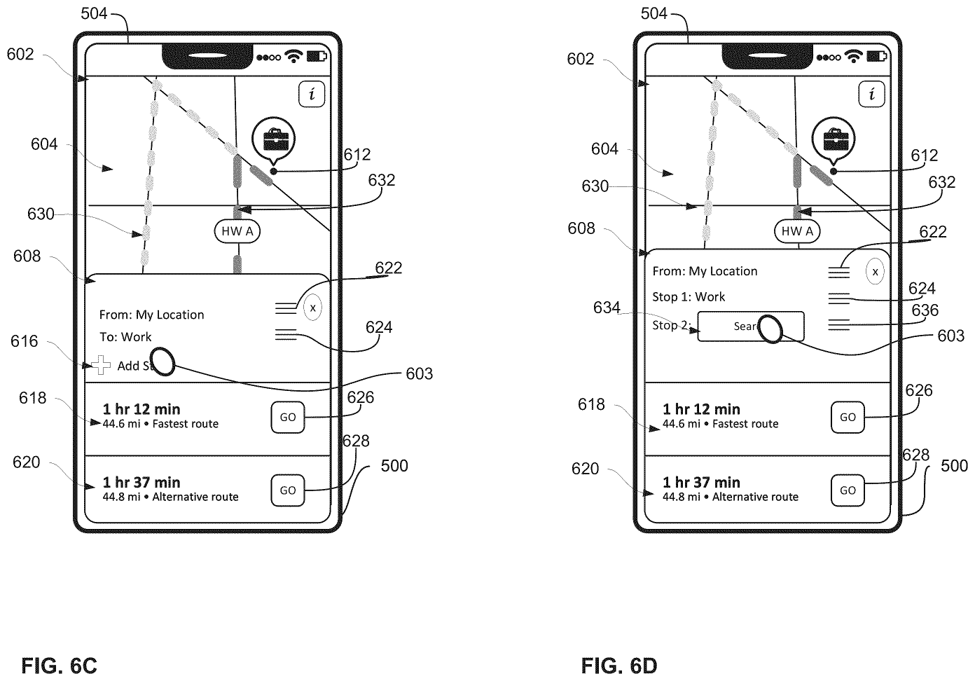

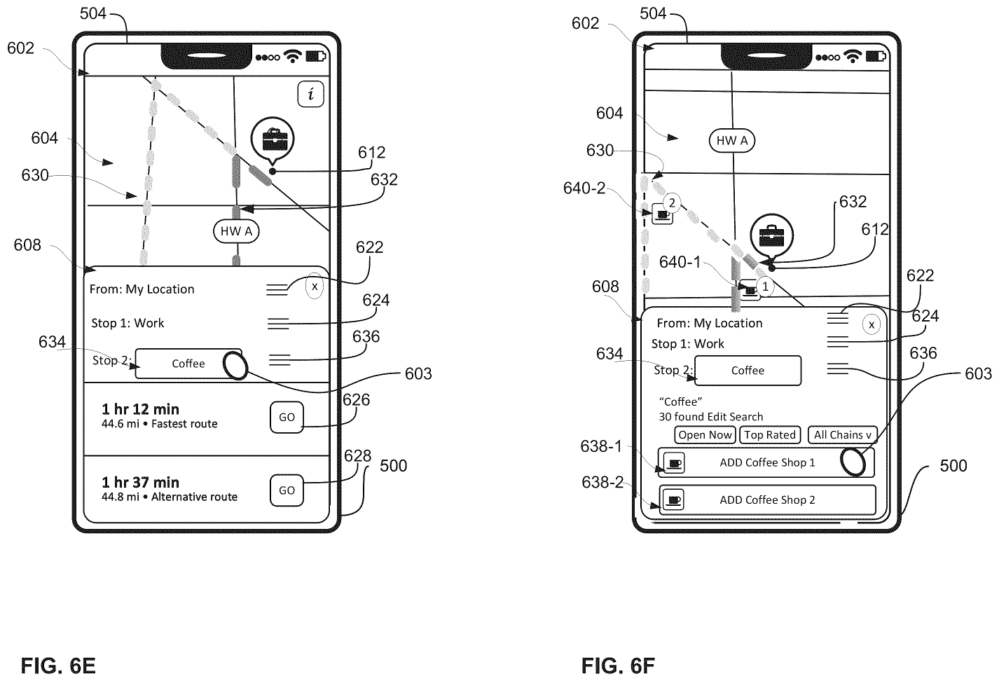

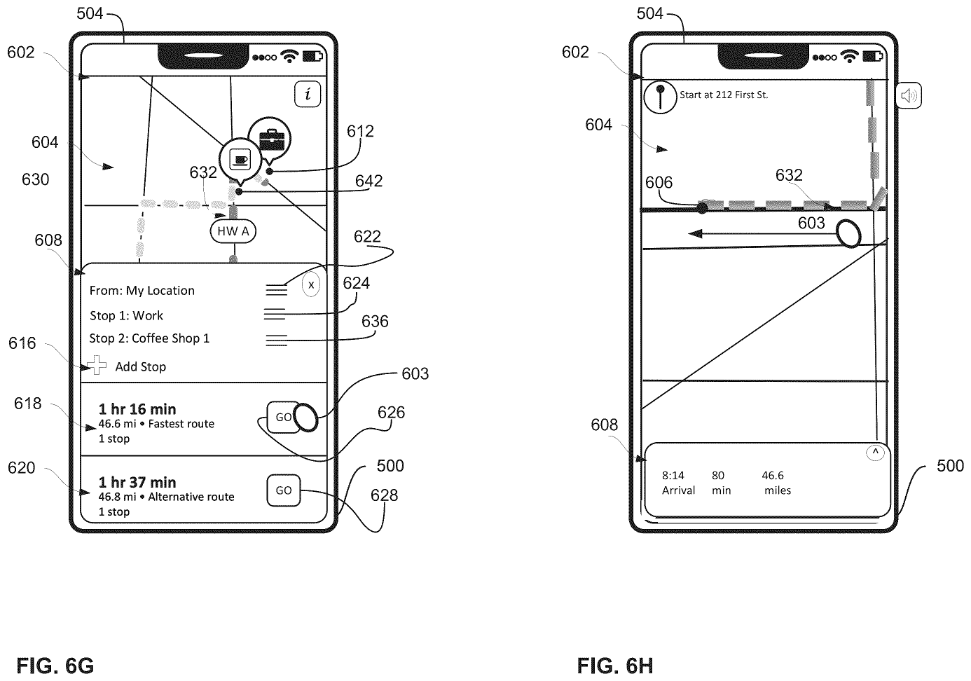

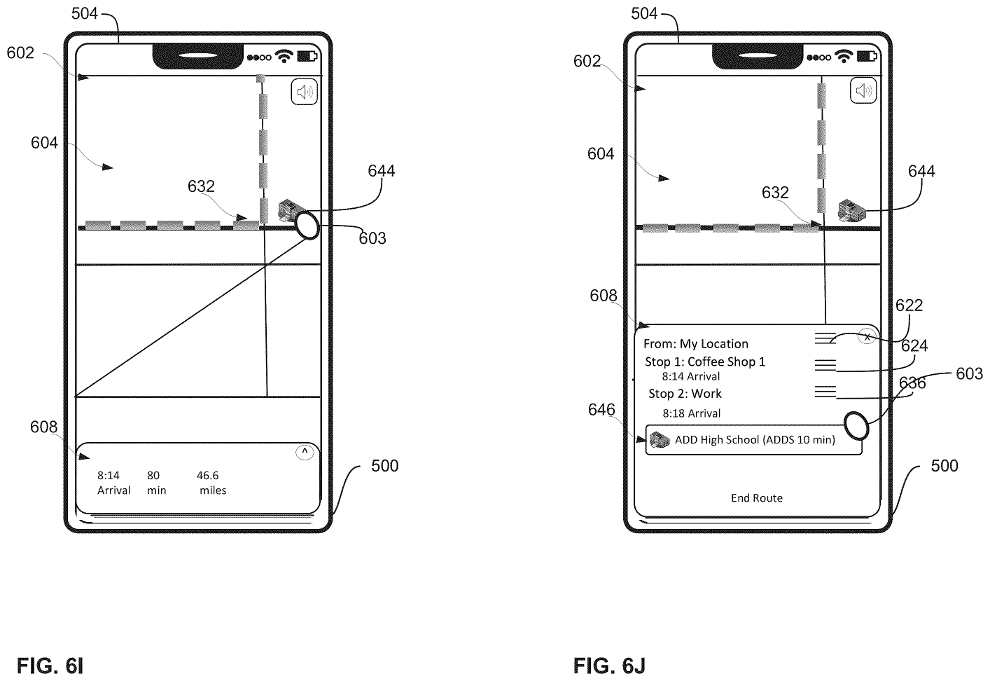

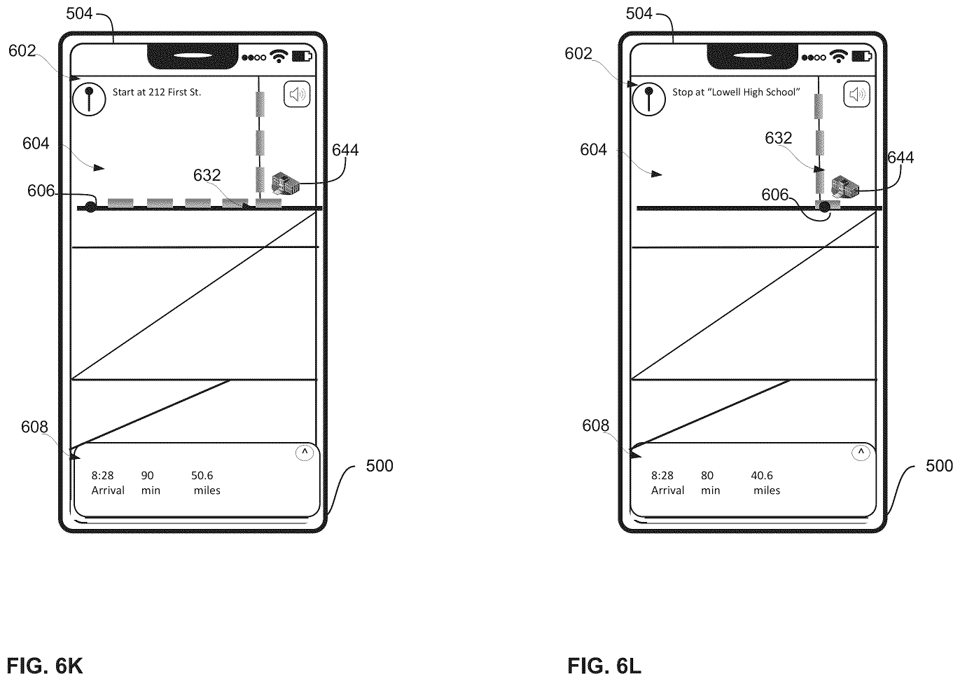

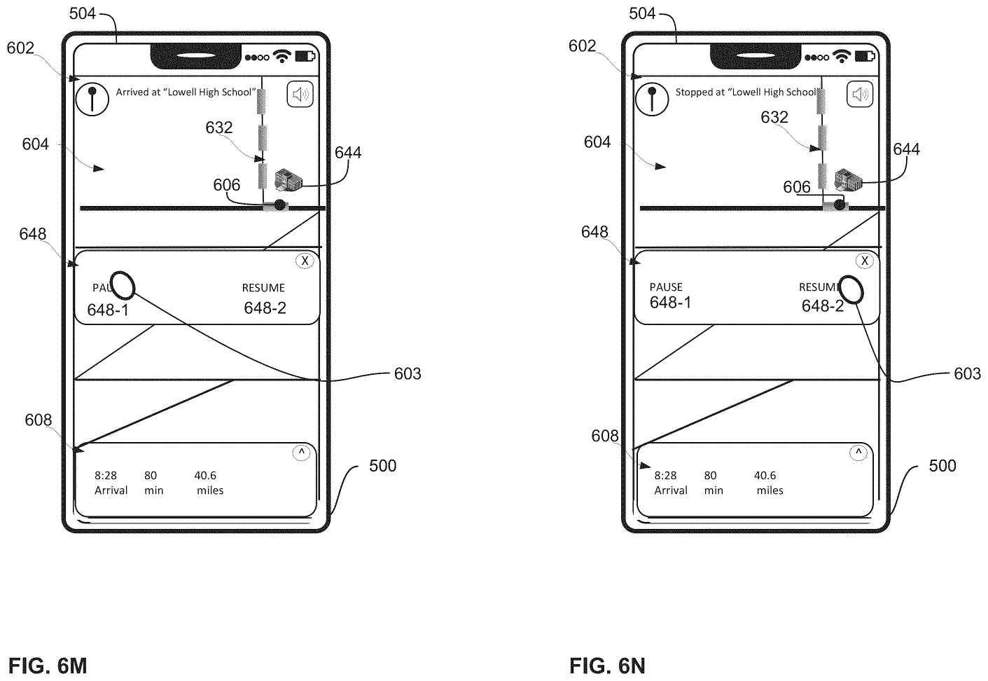

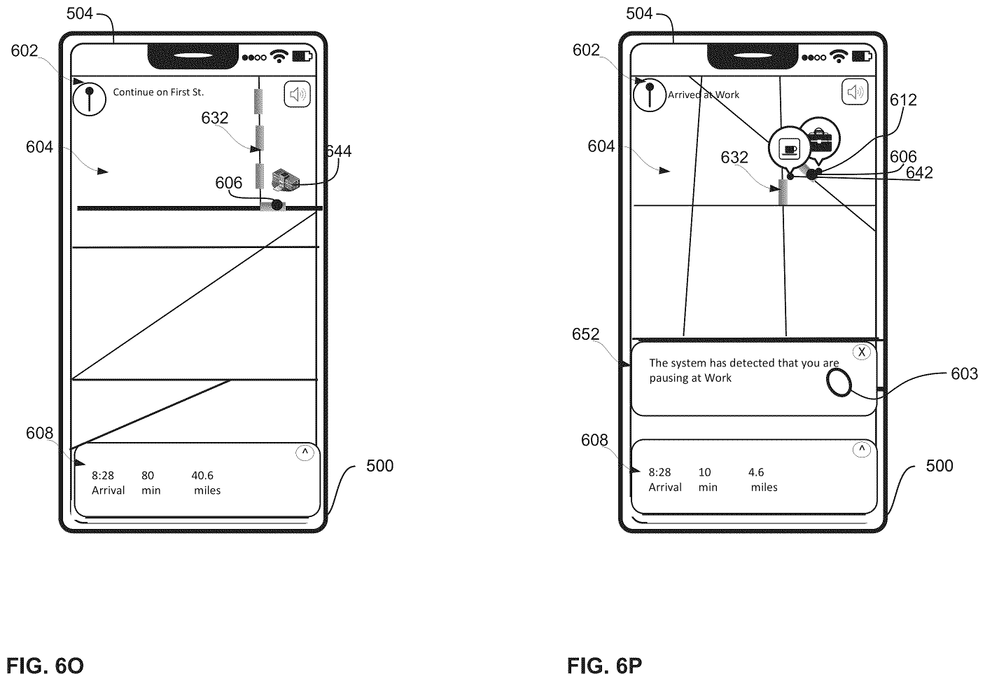

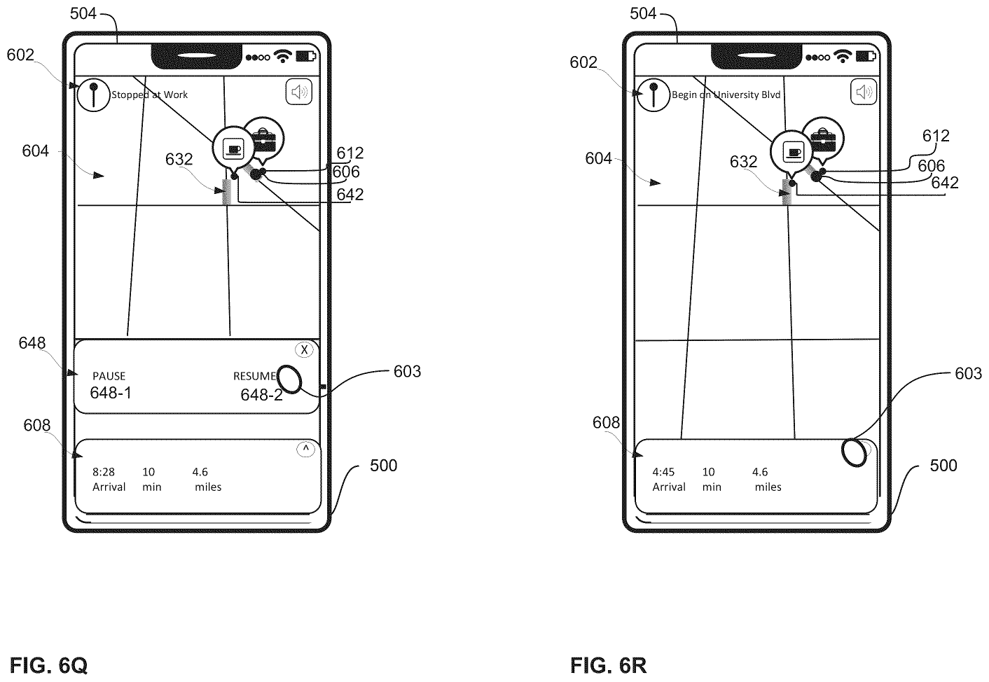

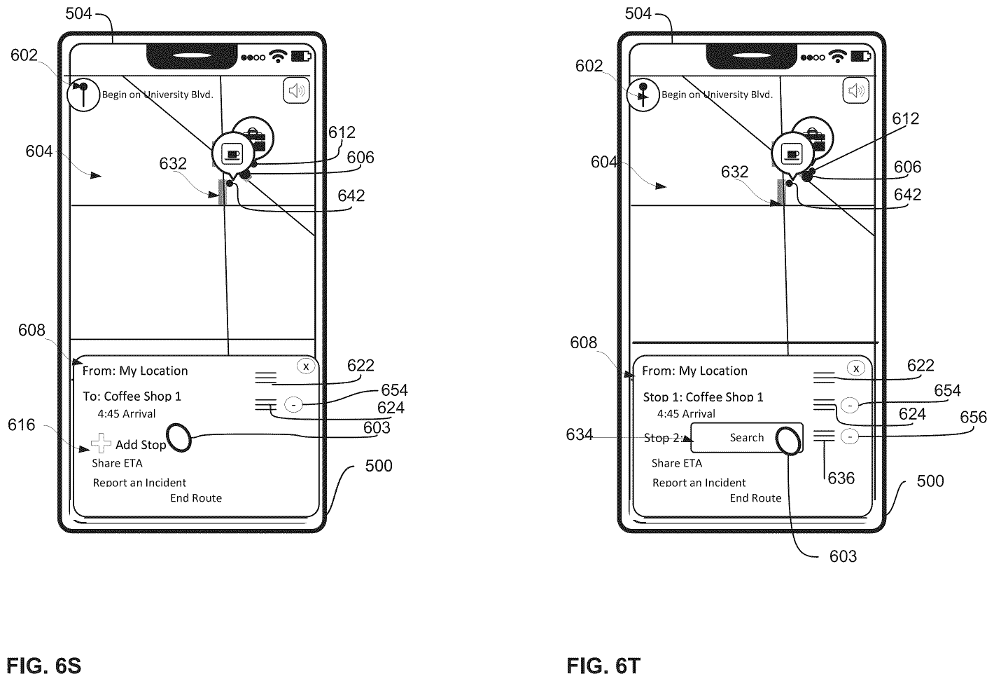

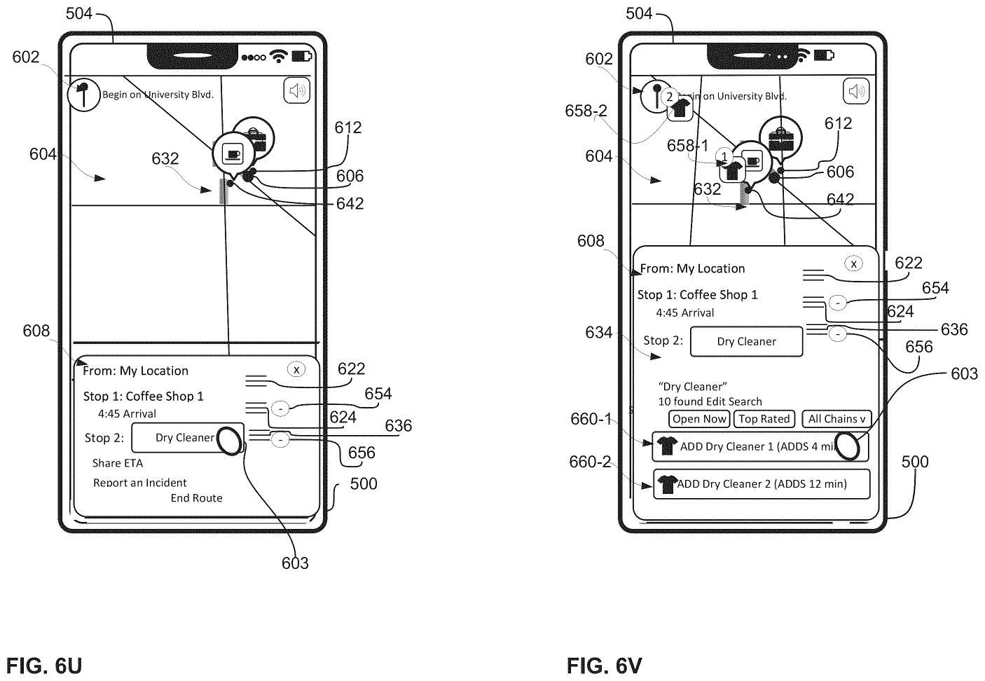

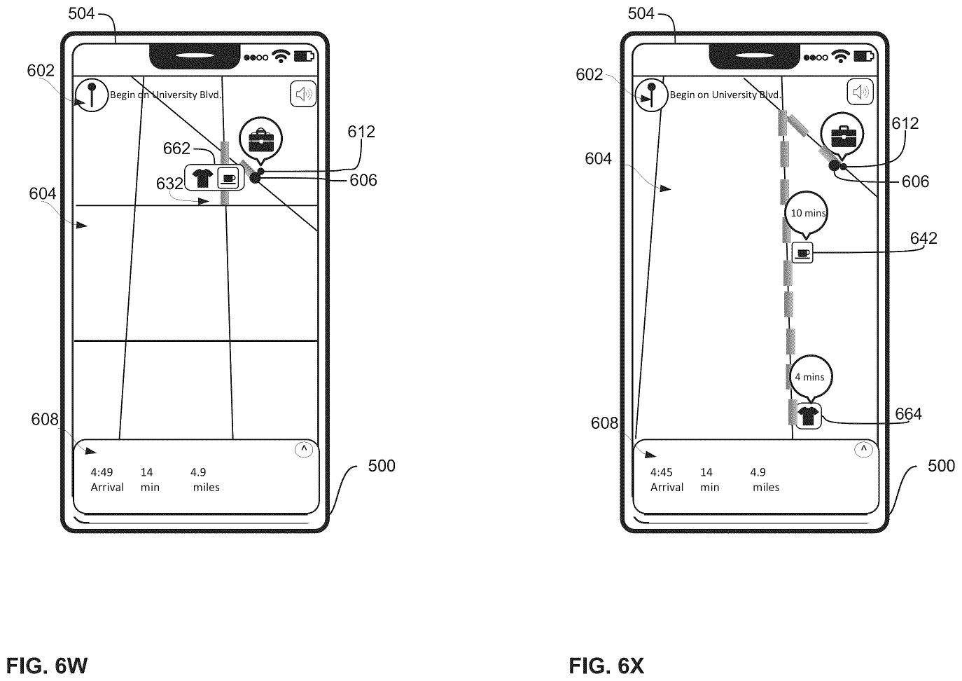

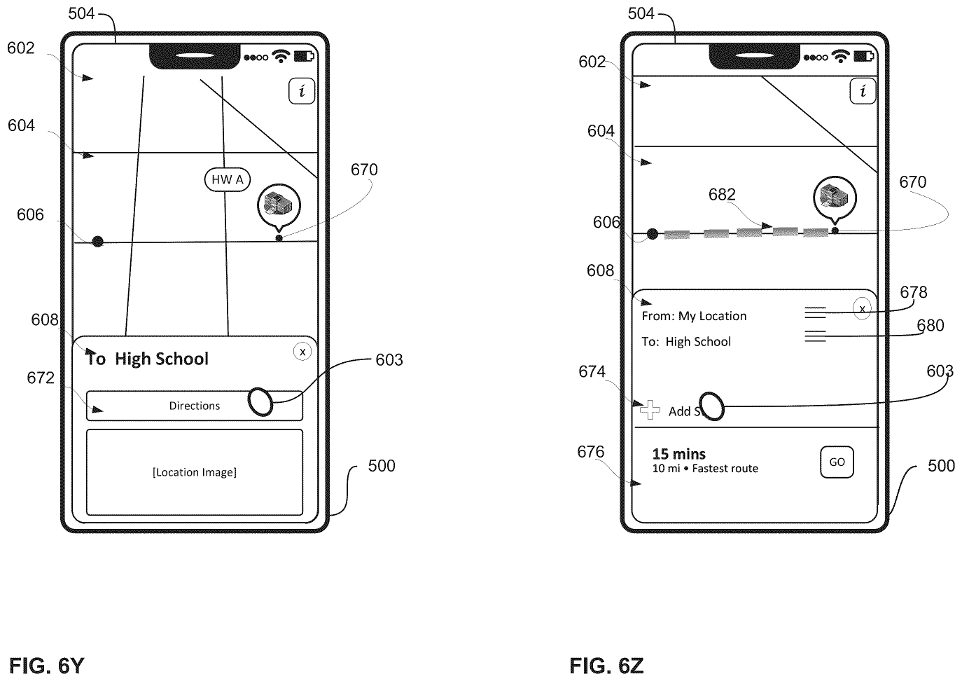

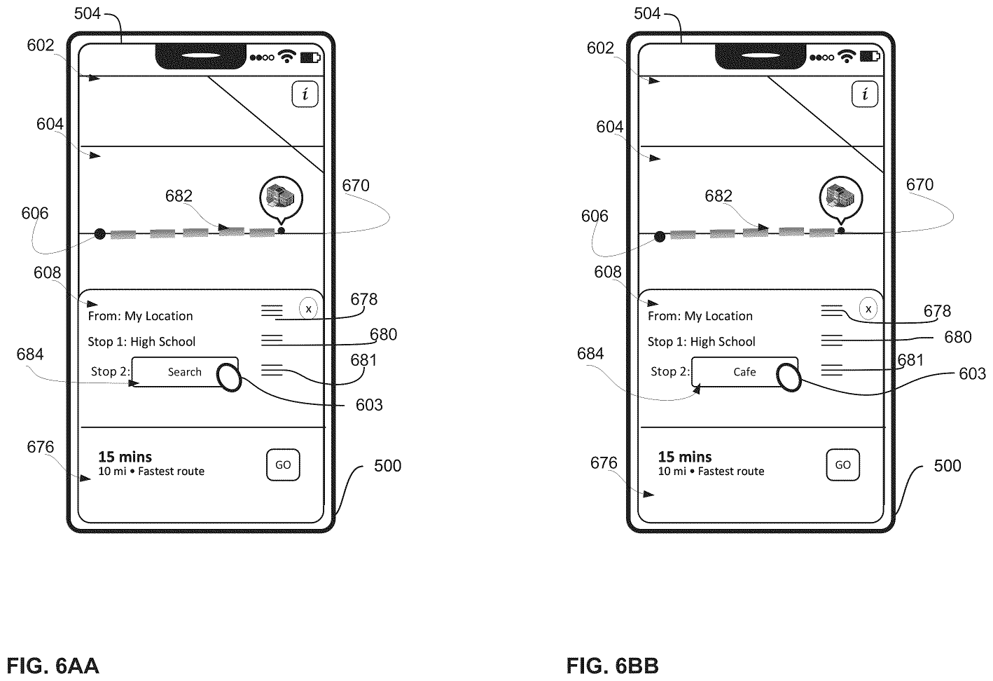

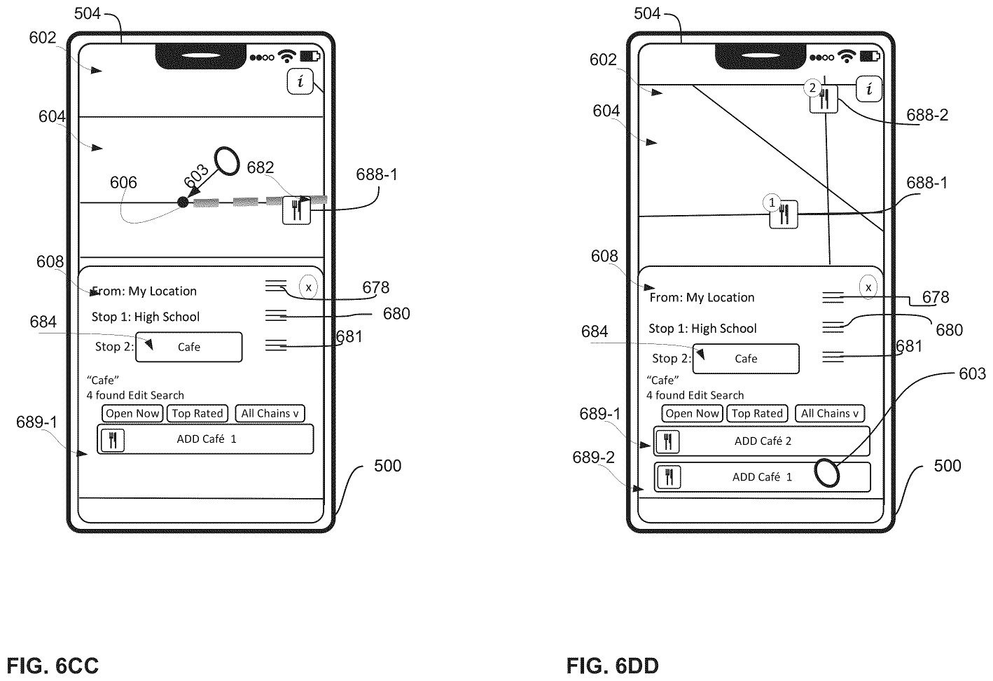

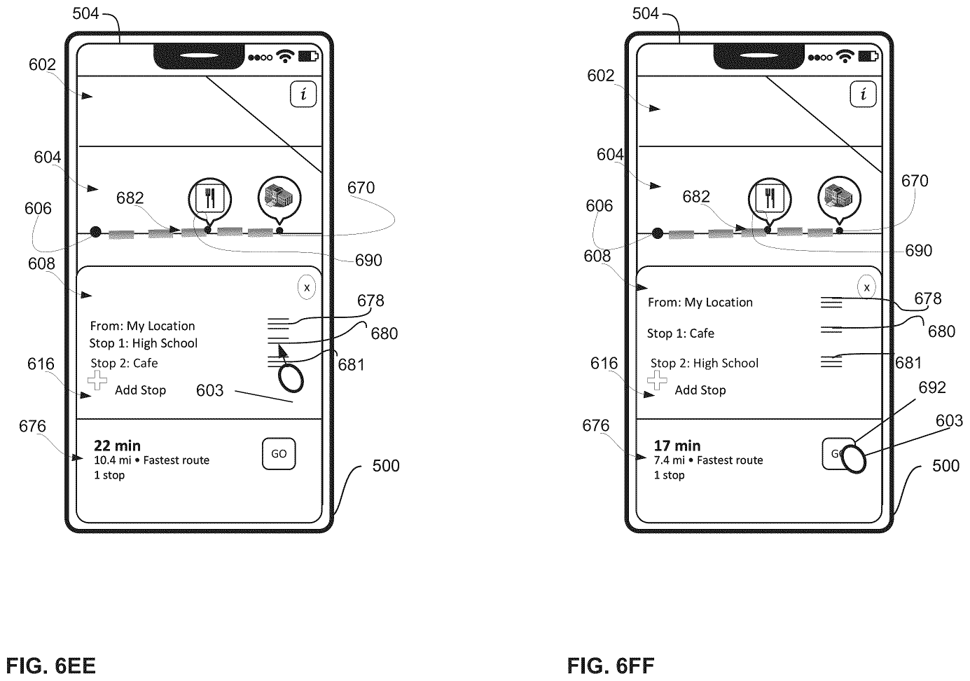

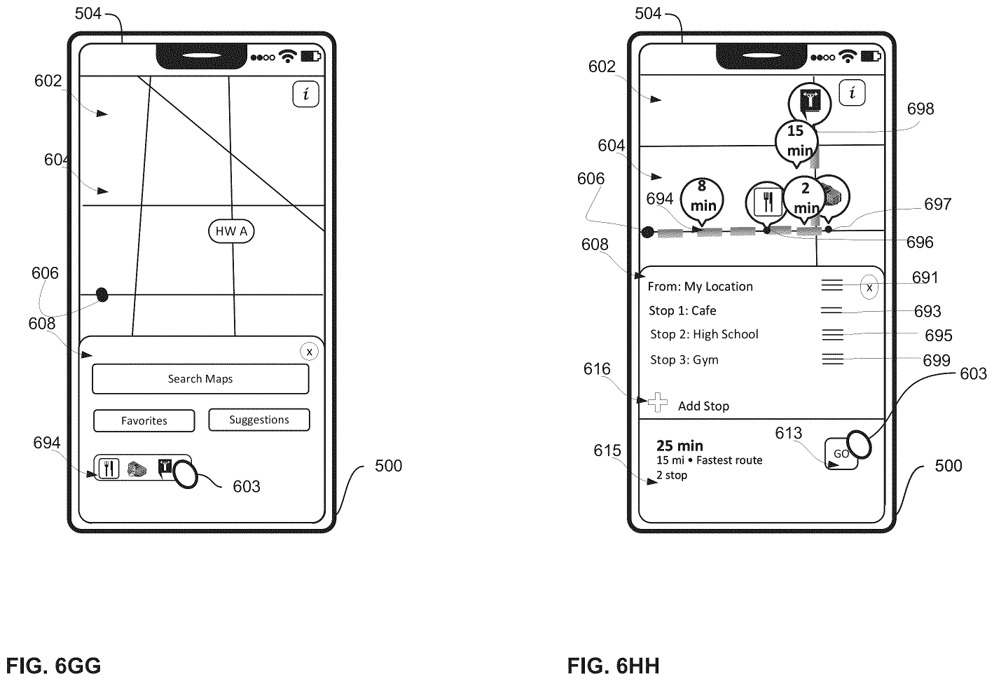

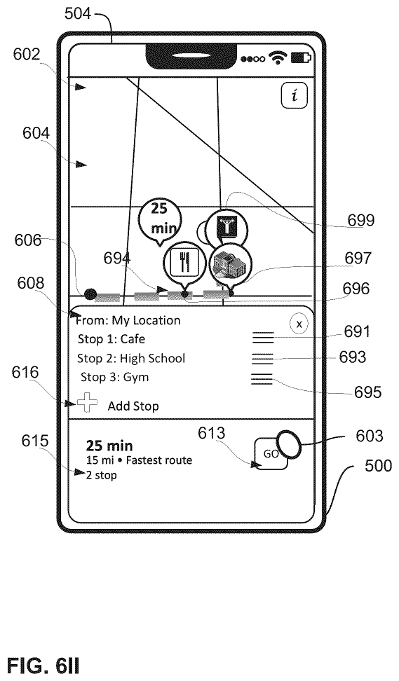

FIGS. 6A-6II illustrate exemplary ways of facilitating display of and interaction with multi-destination navigation routes in accordance with some embodiments of the disclosure. The embodiments in these figures are used to illustrate the processes described below, including the processes described with reference to FIG. 7.

FIG. 6A illustrates an exemplary device 500 that includes touch screen 504. In FIG. 6A, device 500 is displaying a user interface 602 of a maps application. The maps application optionally provides functionality for generating and/or displaying navigation directions on touch screen 504. In FIG. 6A, user interface 602 includes a first portion 604 that includes a representation of a map of a geographic area, including indication 606 of the current location of device 500 in the geographic area. User interface 602 also includes user interface element 608, that includes a search field 610 for searching for locations in the map, and one or more representations 605a-605e of suggested locations for display in user interface 602. Representation 605a represents a home location and is selectable to initiate a process to navigate to the home location. Representation 605b represents a work location and is selectable to initiate a process to navigate to the work location. Representation 605c represents coffee shops and is selectable to navigate to coffee shops. Representation 605d represents restaurants and is selectable to navigate to restaurants. Representation 605e represents an add option and is selectable to add a navigation location.

In FIG. 6A, device 500 detects selection of representation 605b (e.g., via contact 603) corresponding to a work location of the user of device 500. In response, in FIG. 6B, device 500 updates first portion 604 of user interface 602 to include the location of the work location of the user, including displaying indication 612 of the work location on the representation of the map in the first portion 604. Device 500 also updates display of user interface element 608 to include information associated with the work location of the user, including a description of the location, one or more images of the location, and a selectable option 614 that is selectable initiate a process to display navigation directions from the current location of device 500 to the work location of the user.

In FIG. 6B, device 500 detects selection of selectable option 614 (e.g., via contact 603). In response, in FIG. 6C, device 500 updates user interface element 608 to include an indication of a starting location for the navigation directions (e.g., the current location of device 500), an indication of the work location (e.g., a current destination of the navigation directions), an add stop selectable option 616, a representation of a first route 618 from the starting location to the work location, and a representation of a second route 620 from the starting location to the work location. Representation of a first route 618 includes a first color to map out the first route 618 within the representation of the map. Representation of a second route 620 includes a second color to map out the second route 620 within the representation of the map, where the first route 618 and the second route 620 are alternative routes from the starting location to the work location. User interface element 608 also includes a first selectable option 622 and a second selectable option 624 that are selectable to rearrange the respective stops or destination within the route. User interface element 608 further includes first user selectable option 626 and second user selectable option 628 that are selectable to initiate the respective routes. Device 500 also updates first portion 604 of user interface 602 to include first route indication 630 overlaid on the representation of the map, and second route indication 632 overlaid on the representation of the map, where first route indication 630 corresponds to the first route, and second route indication 632 corresponds to the second route.

In FIG. 6C, device 500 detects selection of add stop selectable option 616 (e.g., via contact 603). In response, in FIG. 6D, device 500 updates user interface element 608 to update the description of the work destination (first destination) to read “Stop 1” and include a description of a second destination along with a search field 634 for searching for locations for the second destination. Device 500 further updates user interface element 608 to include third selectable option 636 that is selectable to rearrange the second destination within the route, optionally before or after the second destination is designated by the user.

In FIG. 6D, device 500 detects selection and/or input directed to search field 634 (e.g., via contact 603) that corresponds to a request to search for locations for the new destination that are related to “coffee” (e.g., entered via keyboard or voice input). In response, in FIG. 6E, device 500 updates search field 634 of user interface element 608 to display “Coffee” (e.g., the provided search term), indicating that the user of device 500 is requesting to search for locations related to “Coffee” (e.g., including or providing “Coffee”).

In FIG. 6E, device 500 detects selection of search field 634 (e.g., via contact 603) and/or an input to execute the search based on “coffee”. In response, in FIG. 6F, device 500 updates user interface element 608 to include search results 638-1 and 638-2, along with a description of the search, the overall search results, and filtering user selectable buttons to filter the search results. In FIG. 6E, user interface element 608 includes a user selectable button to filter by which coffee shop is open, which coffee shop is top rated, and which coffee shops are chains. Device 500 also updates first portion 604 to include visual representations 640-1 and 640-2 that correspond to the locations of search results 638-1 and 638-2 on the representation of the map, respectively. Search results 638-1 and 638-2 include a representative icon corresponding to the type of search result and are presented as (or include) a user selectable button for adding the search result to the route at the location in the route defined by the position of search field 634 in the route. It should be noted that in route planning mode, and in FIG. 6F, the search and the corresponding search results are centered around indication 612 or the work location, because the work location is immediately prior to the position of the searched-for destination in the route (e.g., corresponding to the position of search field 634 in the route). If the searched-for destination in the route were immediately after a different stop in the route, the search for that destination would optionally be centered around that different stop in the route, instead. For example, as shown in FIG. 6F, in response to the search in FIG. 6E device 500 has updated portion 604 of user interface 602 to pan the map to be centered on the work location, and is displaying representations of the search results on the panned-to location of the map.

In some embodiments, after the device detects a selection of search field 634 (e.g., via contact 603), before the one or more inputs for completing the execution of the search based on a string of characters are detected, the electronic device can display a user interface with a preliminary list of suggestions for automatically completing a detected string of characters for executing the search. For example, in FIG. 6D, after the user's selection of the search field 634 is detected, before the string of characters for “coffee” are completely detected for the search (e.g., characters “cof” are detected in order), device 500 updates the user interface 602 to display a preliminary list of suggestions (e.g., autocomplete suggestions) for automatically completing the detected string characters for executing the search. In some embodiments, geographical latitude and longitude of the one or more previous and/or future destinations (e.g., work destination, stop 1) can be used to provide suggestions for the detected string of characters. For example, in FIG. 6D, the suggestions to complete the detected string “coffee” for the execution of the search based on “coffee” can depend on the geographical latitude and/or longitude of the “Stop 1” or “Work” to yield more relevant suggestions for the given search query.

In some embodiments, if the route already consists of multiple destinations (e.g., “Stop 1,” “Stop 2,” and “Stop 3”), the suggestions for automatically completing the detected string characters for executing a search for a new destination can depend on the geographical latitude and/or longitude of one or more or all the previous and/or future destinations on the route to yield more relevant suggestions for a given search. In some embodiments, the suggestions for automatically completing the detected string characters for executing a search for a new destination can occur before navigating along the route. In some embodiments, the suggestions for automatically completing the detected string characters for executing a search for a new destination can occur during navigation along the route. For example, before the navigational route is selected by the user (e.g., while the user is planning their trip through selecting a suggested routes such as selecting one of routes 618 and 620), the user can search for a new destination, and the device 500 optionally displays suggestions for automatically completing the detected string characters for executing a search for a new destination. In another example, this process can be done while the user is navigating along the route.

In some embodiments, the suggestions for automatically completing the detected string characters for executing a search for a new destination can depend on the user's current location. In some embodiments, the suggestions for automatically completing the detected string characters for executing a search for a new destination can depend on the user's route selection (e.g., the user's selection from one of routes 618 and 620). In some embodiments, the suggestions for automatically completing the detected string characters for executing a search for a new destination can depend on the portion of the user interface that corresponds to a user's view of the map. For example, as shown in FIG. 6D, the suggestions for automatically completing the detected string characters for executing a search for a new destination can depend on the portion 604 of the user interface 602 that corresponds to the user's view of the map, which may be continuously updated if the user is navigating along the route (e.g., to maintain the user's current location within the view of the map).

In some embodiments, the suggestions for automatically completing the detected string characters for executing a search for a new destination correspond to one or more search results including a group of destinations that is labeled with the keyword associated with the suggestion on a server that is in communication with the electronic device. In some embodiments, in response to the selection of the suggestion being confirmed, the device 500 displays the one or more search results including the group of destinations associated with the suggestion. For example, if the suggestion selected is “coffee,” as shown in FIG. 6D, the device 500 displays the one or more search results including a group of destinations associated with the “coffee” suggestion. In some embodiments, geographical latitude and longitude of the one or more previous and/or future destinations (e.g., work destination, stop 1) can be used to provide one or more search results. For example, in FIG. 6D, the one or more search results for the execution of the search based on “coffee” can depend on the geographical latitude and/or longitude of the “Stop 1” or “Work” to yield more relevant search results for the given search query.

In some embodiments, if the route already consists of multiple destinations (e.g., “Stop 1,” “Stop 2,” and “Stop 3”), the one or more search results can depend on the geographical latitude and/or longitude of one or more or all the previous and/or future destinations on the route to yield more relevant search results for a given search. In some embodiments, the one or more search results are displayed before navigating along the route. In some embodiments, the one or more search results are displayed during navigation along the route. For example, before the navigational route is selected by the user (e.g., while the user is planning their trip through selecting a suggested routes such as selecting one of routes 618 and 620), the user can search for a new destination, and the device 500 displays the one or more search results. In another example, this process can be done while the user is navigating along the route.

In some embodiments, the one or more search results can depend on the user's current location. In some embodiments, the one or more search results can depend on the user's route selection (e.g., the user's selection from one of routes 618 and 620). In some embodiments, the one or more search results can depend on the portion of the user interface that corresponds to a user's view of the map. For example, as shown in FIG. 6D, the one or more search results can depend on the portion 604 of the user interface 602 that corresponds to the user's view of the map, which may be continuously updating if the user is navigating along the route. In some embodiments, the one or more search results can depend on the number of destinations that are visible in the portion of the portion of the user interface that corresponds to a user's view of the map. For example, if only the locations 640-1 and 640-2 of the search results 638-1 and 638-2 are respectively visible, as shown in FIG. 6F, in the portion 604 of the user interface 602, the listing of the search results includes search results 638-1 and 638-2. In some embodiments, the portion of the user interface that corresponds to a user's view of the map can depend on the zoom level of the map. Therefore, in some embodiments, the one or more search results can depend on the zoom level of the map.

In some embodiments, the suggestions for automatically completing the detected string characters for executing a search for a new destination and/or the one or more search results can depend on factors associated with the origin and/or state of navigation when the request is detected. In some embodiments, the factors associated with the origin and/or state of the request can include no suggested routes being displayed or destinations searched for (e.g., autocomplete suggestions and/or searches prior to any route planning or ongoing navigation), one or more suggested routes being displayed and the route navigation having not yet commenced (e.g., autocomplete suggestions and/or searches during route planning and prior to ongoing navigation), and route navigation having commenced (e.g., autocomplete suggestions and/or searches during ongoing navigation). In some embodiments, the electronic device tracks the one or more factors to drive future autocomplete suggestions and/or one or more searches and/or search results. For example, as shown in FIG. 6D, at least one destination is currently defined, but none of the suggested routes 618 or 620 are selected. In this example, the autocomplete suggestions and/or the search query and/or search results can depend on and/or be associated with the factors corresponding to a destination being defined, but no routes being selected. Moreover, future autocomplete suggestions and/or searches and/or search results can depend on the above-tracked factors about the origins of the autocomplete suggestions and/or the search query and/or search results.

In FIG. 6F, device 500 detects selection of search result 638-1 (e.g., via contact 603) and/or an input to add search result 638-1 to the route as Stop 2. In response, in FIG. 6G, device 500 updates user interface element 608 to include a description of the second destination (Coffee Shop 1) and user interface element 608 continues to include add stop selectable option 616. Device 500 further updates representation 618 to include information about the first proposed updated route and representation 620 to include information about the second proposed updated route. The information includes the number of stops in the route, the distance of the route, and whether the route is the fastest route or an alternative route. Device 500 further updates first portion 604 to include the location of Coffee Shop 1 (e.g., the second destination), including displaying an indication 642 of the Coffee Shop 1 location on the representation of the map in the first portion 604, as well as updates first route and the second route to include the second destination.

In FIG. 6G, device 500 detects selection of first user selectable option 626 (e.g., via contact 603) corresponding to the first route. In response, in FIG. 6H, device 500 updates user interface element 608 to become a first navigation tray that describes an arrival time for the route, a time left in the route, and/or a distance left in the route. Device 500 further updates first portion 604 of user interface 602 to zoom in around indication 606 (e.g., the current location of device 500) and/or the beginning of route 632, as well as display instructions for the present step on route 632 (e.g., “Start at 212 First St.”). First portion 604 of user interface 602 is optionally manipulable such that the user of device 500 can provide input to zoom in and out of the representation of the map and/or pan the representation of the map left, right, up, down, and diagonally, independent of movement of the current location of device 500 along the route.

In FIG. 6H, device 500 detects an input panning the representation of the map to the right (e.g., via contact 603 moving to the left). In response, in FIG. 6I, device 500 updates first portion 604 of user interface 602 to include a representation of the map that is further to the right than in FIG. 6H, which includes an indication 644 of a school location on the representation of the map (e.g., shown as an image or icon of the school). Indication 644 is selectable to initiate a process to add the corresponding school as an additional destination along route 632.

In FIG. 6I, device 500 detects selection of indication 644 (e.g., via contact 603). In response, in FIG. 6J, device 500 updates user interface element 608 to include a description of the starting location for the navigation direction, a description of the first destination in the route (e.g., Coffee Shop 1) along with an estimated arrival time for the first destination, and a description of the second destination along with an estimated arrival time for the second destination. User interface element 608 also includes first selectable option 622, second selectable option 624, and third selectable option 636, as described with reference to FIG. 6F. User interface element 608 also includes selectable option 646 that is selectable to initiate a process to add the location that corresponds to indication 644 to route 632 (e.g., at the end of the route, after the last existing destination in the route, such as after Work). In navigation mode, and in FIG. 6J, selectable option 646 includes and/or is displayed with a description of the amount of time that will be added to route 632 if the destination is added to the route.

In FIG. 6J, device 500 detects selection of selectable option 646 (e.g., via contact 603). In response, in FIG. 6K, device 500 adds the location that corresponds to indication 644 to route 632 (e.g., to the end of the route), and updates the descriptions in user interface element 608 to reflect the addition of the respective location. For instance, the description of the arrival time for the route has been updated to 8:28, the time left in the route has been updated to 90 min, and the distance left in the route has been updated to 50.6 miles. Device 500 further updates first portion 604 of user interface 602 to zoom in around indication 606 and/or the beginning of route 632, which now includes indication 644.

From FIG. 6K to FIG. 6L, device 500 detects that the location of device 500 has moved along route 632 to a threshold distance (e.g., within 0.1, 0.25, 0.5 1, 5, 10, 15, or 20 miles) within the location corresponding to indication 644, and in response, updates first portion 604 of user interface 602 to include the current location of device 500 via indication 606, and the remaining route 632. Device 500 further updates user interface element 608 to include an updated time remaining in the route, and an updated distance left in the route. For instance, the time left in the route has been updated to 80 min, and the distance left in the route has been updated to 40.6 miles.

From FIG. 6L to FIG. 6M, device 500 displays user interface element 648 including user selectable option 648-1 that is selectable to initiate a process to pause route 632 (e.g., so device 500 does not begin presenting navigation instructions to the next destination in the route), and user selectable option 648-2 that is selectable to initiate a process to resume or continue route 632 (e.g., so device 500 does begin presenting navigation instructions to the next destination in the route). User interface element 648 is displayed in response to the electronic device nearing indication 644. In some embodiments, user interface element 648 is automatically displayed and in alternative embodiments, user interface element 648 is displayed in response to user selection. In FIG. 6M, device 500 detects selection of user selectable option 648-1 (e.g., via contact 603). In response, in FIG. 6N, device 500 pauses the navigation of route 632.

In FIG. 6N, after pausing the navigation along the route for some time which may or may not include closing or ceasing display of user interface 602, device 500 detects a redisplaying of user interface 602 and displays user interface element 648 in user interface 602. Device 500 detects selection of user selectable option 648-2 (e.g., via contact 603). In response, in FIG. 6O, device 500 resumes navigation of route 632 by displaying instructions to “Continue on First St.”

From FIG. 6O to FIG. 6P, device 500 detects that device 500 is pausing (e.g., for a threshold amount of time, such as 1, 3, 5, 20, 30, 60, 120, 360 or 720 seconds) within a threshold distance (e.g., 0.1, 0.25, 0.5, 1, 5, 10, 15, or 20 miles) of the location corresponding to indication 612 (e.g., Work), and automatically pauses progressions along route 632. In response, in FIG. 6P, device 500 displays indication 652 to alert the user of device 500 that progression (e.g., 1, 5, 10, 15, or 20 miles) along route 632 is paused. Indication 652 includes details about if and why the navigation is paused. Device 500 further updates user interface element 608 to include an updated time remaining in the route, and an updated distance left in the route. For instance, the time left in the route has been updated to 10 min, and the distance left in the route has been updated to 4.6 miles.

In FIG. 6P, device 500 detects selection of indication 652 (e.g., via contact 603). In response, in FIG. 6Q, device 500 displays user interface element 648 as described with reference to FIG. 6M.

In FIG. 6Q, device 500 detects selection of user selectable option 648-2 (e.g., via contact 603). In response, in FIG. 6R, device 500 resumes the navigation of route 632 and updates user interface element 608 to include an updated arrival time for the route, an updated time remaining in the route, and an updated distance left in the route. For instance, the arrival time has been updated to 4:45, the updated time remaining in the route has been updated to 10 min, and the updated distance has been updated to 4.6 mi. Furthermore, device 500 displays instruction “Begin on University Blvd” in user interface 602.

In FIG. 6R, while on the navigation route, device 500 detects selection of an expand option in the top corner of user interface element 608 to expand user interface element 608 (e.g., via contact 603). In response, in FIG. 6S, device 500 expands user interface element 608 to include a description of the starting location of the remaining route (e.g., the current location of device 500), a description of the second destination in the route (Coffee Shop 1) along with an estimated arrival time for the second destination, an add stop selectable option 616, first selectable option 622, and second selectable option 624 that are likewise operable, as described for example with reference to FIG. 6G. User interface element 608 also optionally includes a selectable option to share the route with another user, such as via text message, email, or the like. User interface element 608 further includes remove option 654 that is selectable to initiate a process to remove the second destination (Coffee Shop 1) from route 632.

In FIG. 6S, device 500 detects selection of add stop selectable option 616 (e.g., via contact 603). In response, in FIG. 6T, device 500 updates user interface element 608 to update the description of the second destination to read “Stop 1” and include a description of a third destination after the second destination in the route, along with a search field 634 for searching for locations for the third destination. Device 500 also updates user interface element 608 to include third selectable option 636 as described with reference to FIG. 6F, and remove option 656 that is selectable to initiate a process to remove the third destination from route 632.

In FIG. 6T, device 500 detects selection and/or input directed to search field 634 (e.g., via contact 603) that corresponds to a request to search for locations related to “Dry Cleaner”. In response, in FIG. 6U, device 500 updates search field of user interface element 608 to display “Dry Cleaner,” indicating that the user of device 500 is requesting to search for locations including or providing dry cleaning services.

In FIG. 6U, device 500 detects selection of search field 634 (e.g., via contact 603) and/or an input to execute the search for “Dry Cleaner”. In response, in FIG. 6V, device 500 updates user interface element 608 to include search results 660-1 and 660-2, along with a description of the search, the overall search results, and filtering user selectable buttons to filter the search results. Device 500 also updates first portion 604 to include visual representations 658-1 and 658-2 that correspond to the locations of search results 658-1 and 658-2 on the representation of the map, respectively. Search results 658-1 and 658-2 include a representative icon or image corresponding to the type of search result, a time that would be added the route 632 if the search result is added to the route, and are presented as or include a user selectable options for adding the search results to the route. It should be noted that, during navigation (as in FIG. 6V), the search and corresponding search results are centered around the current location of device 500 (e.g., corresponding to indication 606), rather than being centered around any particular destinations in the route.

In FIG. 6V, device 500 detects selection of search result 660-1 (e.g., via contact 603) and/or input to add search result 660-1 to the route (e.g., to the position in the route corresponding to the position in the route of search field 634 in FIGS. 6U-6V). In response, in FIG. 6W, device 500 updates user interface element 608 to indicate an updated arrival time for the updated route, a time left in the updated route, and a distance left in the updated route. For instance, the arrival time is updated to 4:49, the time remaining in the route is updated to 14 min, and the distance remining in the route is updated to 4.9 miles. Device 500 further updates first portion 604 of user interface 602 to include a representation of the third destination in route 632 and display a stacked indication 662 for the dry cleaner and coffee shop at the location on the map corresponding to the dry cleaner and the coffee shop. It should be noted that stacked indication 662 is displayed by device 500, because the representation of the map is presently shown in a relatively zoomed-out view, and individual indications for the dry cleaner and the coffee shop would optionally overlap is displayed separately on the map.

From FIG. 6W to FIG. 6X, device 500 detects that the representation of the map has been zoomed in (e.g., in response to an input to zoom into the map, such as a pinch input on touch screen 504). In response, in FIG. 6X, device 500 zooms into the indication 632 of the route to expand stacked indication 662 into separate indications for Coffee Shop 1 and Dry Cleaner 1 displayed at their corresponding locations on the map. In Particular, in FIG. 6X, device 500 updates first portion 604 of user interface 602 to include a zoomed-in presentation of indication 612 (corresponding to Work), indication 642 (corresponding to Coffee Shop 1), and indication 664 (corresponding to Dry Cleaner 1). Device 500 further updates first portion 604 of user interface 602 to include an indication of a first estimated amount of time that it will take to progress along the route from Work (corresponding to indication 612) to Dry Cleaner 1 (corresponding to indication 664), and an indication of a second estimated amount of time that it will take to progress along the route from Dry Cleaner 1 (corresponding to indication 664) to Coffee Shop 1 (corresponding to indication 642).

FIG. 6Y illustrates an additional way of facilitating multi-destination navigation routes in accordance with some embodiments of the disclosure. In FIG. 6Y, device 500 displays first portion 604 of user interface 602 to include the location of a high school, including displaying indication 670 of the high school location on the representation of the map in the first portion 604. Device 500 also displays user interface element 608 to include information associated with the high school, including a description of the location, one or more images of the location, and a selectable option 672 that is selectable to initiate a process to display navigation directions from the current location of device 500 to the high school location.

In FIG. 6Y, device 500 detects selection of selectable option 672 (e.g., via contact 603). In response, in FIG. 6Z, device 500 updates user interface element 608 to include a description of the starting location of the route (My Location), a description of the first destination (High School), an add stop selectable option 674, and a representation 676 of a first route from the starting location to the first destination. Representation 676 further includes a distance for the route, a time for the route, whether it is the fastest/slowest route, and a selectable option to initiate the route. User interface element 608 also includes a first selectable option 678 and a second selectable option 680 to reposition the respective locations to which they correspond within the route. Device 500 also updates first portion 604 of user interface 602 to include first visual indication 682 of the first route overlaid on the representation of the map, similar to the updating in FIG. 6C.

In FIG. 6Z, device 500 detects selection of add stop selectable option 674 (e.g., via contact 603). In response, in FIG. 6AA, device 500 updates user interface element 608 to update the description of the first destination to read “Stop 1”, and include a description of a second destination to be added to the route along with a search field 684 for searching for locations for the second destination. Device 500 further updates user interface element to include third selectable option 681 that is selectable to initiate a process to reposition the respective destination within the route.

In FIG. 6AA, device 500 detects selection and/or input directed to search field 684 (e.g., via contact 603) corresponding to a request to search for locations associated with “Cafe”. In response, in FIG. 6BB, device 500 updates search field 684 of user interface element 608 to display “Cafe,” indicating that the user of device 500 is requesting to search for locations including or providing “Cafe.”

In FIG. 6BB, device 500 detects selection of search field 684 (e.g., via contact 603) and/or an input to execute the search. In response, in FIG. 6CC, device 500 updates user interface element 608 to include search result 6891, along with a description of the search, the overall search results, and filtering user selectable buttons to filter the search results. Device 500 also updates first portion 604 to include visual representation 688-1 that corresponds to the location of search result 689-1 on the representation of the map. Search result 689-1 includes a representative icon corresponding to the type of search result, and is presented as or includes a user selectable button for adding the search result to the route. In FIG. 6CC, device 500 centers the search on the location of indication 606, because navigation is currently enabled.

In FIG. 6CC, device 500 detects input for panning the representation of the map diagonally up and to the right (e.g., via movement of contact 603 down and to the left). In response, in FIG. 6DD, device 500 updates first portion 604 of user interface 602 to include a portion of the representation of the map that is up and to the right relative to the portion shown in FIG. 6CC, which corresponds to a geographic region that includes an additional search result for the search “Cafe”. Accordingly, device 500 updates user interface element 608 to include the additional search result 689-2. Device 500 further updates first portion 604 of user interface 602 to include visual representation 688-2 that corresponds to the location of search result 689-2 on the representation of the map.

In FIG. 6DD, device 500 detects selection of search result 689-2 (e.g., via contact 603) and/or an input to add search result 689-2 to the route (e.g., to the end of the route). In response, in FIG. 6EE, device 500 updates user interface element 608 to include a description of the second destination (Cafe) and continues to include add stop selectable option 616. Device 500 further updates the first route and representation 676 to include information about the updated route. For instance, representation 676 now includes an updated time and distance (e.g., 22 min and 10.4 mi) as well as indicates that 1 stop is to be made along the route. Device 500 further updates first portion 604 to include the location of the Cafe location corresponding to the second destination, including displaying an indication 690 of the Cafe location on the representation of the map in the first portion 604, as well as updates first route indication 682 to include the second destination.

In FIG. 6EE, device 500 detects selection of third selectable option 681 (e.g., via a touchdown of contact 603 on selectable option 681, and a drag of contact 603 up to the location of selectable option 680) to move the second destination (Cafe) into the first destination spot in the route, and thus move the first destination (High School) into the second destination spot in the route. In response, in FIG. 6FF, device 500 updates user interface element 608 to indicate the previous second destination in the first destination spot, and the previous first destination in the second destination spot. Representation 676 is likewise updated based on the movement of the destinations, updating the time to 17 min and the distance to 7.4 mi. In FIG. 6FF, device 500 detects selection of first user selectable option 692 (e.g., via contact 603). In response, device 500 initiates navigation directions along the first route, and updates user interface element 608 to include a first navigation tray that indicates an arrival time for the route, a time left in the route, and a distance left in the route, as shown previously with respect to FIG. 6H.

FIG. 6GG illustrates an additional way of facilitating multi-destination navigation routes in accordance with some embodiments of the disclosure. In FIG. 6GG, device 500 displays first portion 604 of user interface 602 to include the location of a high school, including displaying indication 606 of the current location of device 500 on the representation of the map included in first portion 604. Device 500 further displays suggested locations and/or routes for display in user interface 602. In FIG. 6GG, suggested route 694 is a route that was configured on a second electronic device that is different from electronic device 500 but that shares a user account with device 500, as described in more detail with reference to method 700.

In FIG. 6GG, device 500 detects selection of suggested route 694 (e.g., via contact 603). In response, in FIG. 6HH, device 500 updates first portion 604 of user interface 602 to include representation 694 corresponding to the suggested route overlaid on the map, which includes a first destination corresponding to indication 696 (Cafe, Stop 1) on the map in first portion 604, a second destination corresponding to indication 697 (High School, Stop 2) on the map in first portion 604, and a third destination corresponding to indication 698 (Gym, Stop 3) on the map in first portion 604. Device 500 further updates first portion 604 of user interface 602 to include an indication of a first estimated amount of time to travel from the current location of device 500 (e.g., corresponding to indication 606) to Cafe (corresponding to indication 696) that is displayed in association with the portion of indication 694 corresponding to the first segment of the route, a second indication of a second estimated amount of time to travel from Cafe (corresponding to indication 696) to High School (corresponding to indication 697) that is displayed in association with the portion of indication 694 corresponding to the second segment of the route, and a third estimated amount of time to travel from High School (corresponding to indication 697) to Gym (corresponding to indication 698) that is displayed in association with the portion of indication 694 corresponding to the third segment of the route.

Device 500 further updates user interface element 608 to include representation 615 of the suggested route that corresponds to route indication 694 displayed over the representation of the map, and further includes first selectable option 691, second selectable option 693, third selection option 695, and fourth selectable option 699 that are selectable to reposition the respective destinations within the route. Representation 615 includes details about the suggested route such as the distance, the time, whether the route is the fastest/slowest, how many stops in the route, and a selectable option to initiate the route. In FIG. 6HH, device detects selection of selectable option 613 (e.g., via contact 603). In response, device 500 updates user interface element 608 to include a first navigation tray that describes an arrival time for the route, a time left in the route, and a distance left in the route, as shown previously with respect to FIG. 6H.

FIG. 6II presents an alternative to 6HH where electronic device has not yet entered navigation mode and is in a relatively zoomed-out state as compared with FIG. 6HH. In FIG. 6II, device 500 includes an amount of time from indication 606 to indication 696. In FIG. 6II, user interface 602 optionally includes everything described with reference to FIG. 6HH, except that instead of displaying separate indications of estimated amounts of time for the different segments of the route, because the zoom level in FIG. 6II of the map is less than a threshold zoom level (e.g., less than 1, 3, 5, 10, 20, 30, 50 or 75% zoom level), In FIG. 6II, suggested route 694 is displayed with an estimated time of 25 minutes for the entire route that includes all three destinations.

In FIG. 6II, device detects selection of selectable option 613 (e.g., via contact 603). In response, device 500 updates user interface element 608 to include a first navigation tray that describes an arrival time for the route, a time left in the route, and a distance left in the route, as shown previously with respect to FIG. 6H.

FIG. 7 is a flow diagram illustrating a method 700 of exemplary ways of searching for stops to incorporate into a multistep route in accordance with some embodiments, such as in FIGS. 6A-6II. The method 700 is optionally performed at an electronic device such as device 100, device 300, or device 500 as described above with reference to FIGS. 1A-1B, 2-3, 4A-4B and 5A-5H. Some operations in method 700 are, optionally combined and/or order of some operations is, optionally, changed.

As described below, the method 700 provides ways to facilitate interaction with multi-destination navigation routes. The method reduces the cognitive burden on a user when interacting with a user interface of the device of the disclosure, thereby creating a more efficient human-machine interface. For battery-operated electronic devices, increasing the efficiency of the user's interaction with the user interface conserves power and increases the time between battery charges.

In some embodiments, method 700 is performed at an electronic device (e.g., 500) in communication with a display generation component (e.g., 504) and one or more input devices (e.g., 504), such as in FIG. 6A. For example, a mobile device (e.g., a tablet, a smartphone, a media player, or a wearable device) including wireless communication circuitry, optionally in communication with one or more of a mouse (e.g., external), trackpad (optionally integrated or external), touchpad (optionally integrated or external), remote control device (e.g., external), another mobile device (e.g., separate from the electronic device), a handheld device (e.g., external), and/or a controller (e.g., external), etc.). In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc. In some embodiments, method 700 is performed at or by an automobile (e.g., at an infotainment system of an automobile having or in communication with one or more display generation components and/or input devices).

In some embodiments, while displaying, via the display generation component, a route configuration user interface (e.g., 602), the electronic device detects (702a), via the one or more input devices, a first user input corresponding to a request to add a first destination to a route, such as contact 603 in FIG. 6B. In some embodiments, the route configuration user interface is a user interface of a map and/or navigation application that enables a user of the electronic device to configure a route from a beginning location to a first destination on a virtual map. In some embodiments, the user opens the route configuration user interface to configure a route from a beginning location, such as the user's current location. The beginning location is optionally a user entered location (e.g., the user provides an input with an address of the beginning location). For instance, the user optionally begins a route from the user's home. In some embodiments, the electronic device receives a user input that corresponds to a request to add the first destination to the route. This first destination is optionally added to the route by the user searching within the user interface (e.g., searching for a destination, and selecting a selectable option associated with a destination displayed in response to the search to generate and/or display a navigation route from the beginning location to the first destination). Alternatively, the first destination is optionally entered manually by the user. For instance, the user optionally provides input to add the user's work address as a first destination of the route.

In some embodiments, in response to detecting the first user input, the electronic device adds (702b) the first destination to the route, such as shown in user interface element 608 in FIG. 6C. In some embodiments, the first input includes a selection of the first destination or selection of a selectable option associated with the first destination (e.g., a “get directions” button associated with the first destination), and the first destination becomes the first destination of the route. The route is optionally displayed on the virtual map. For instance, the virtual map optionally includes, as a route line overlay on the map, a route from the user's home location to the user's work location.

In some embodiments, while the first destination is included in the route, the electronic device detects (702c), via the one or more input devices, a second user input corresponding to a request to search for a second destination to be added to the route, such as contact 603 in FIG. 6D. In some embodiments, and prior to the user finalizing the route and/or initiating navigation instructions for traversing the route, the electronic device receives a second user input that corresponds to a request to search for a second destination to be added to the route. For instance, the user optionally provides input to add a coffee stop to the route after work location on the route. Accordingly, the electronic device optionally receives input corresponding to a request to search for coffee shops.

In some embodiments, in response to detecting the second user input (702d), in accordance with a determination that the second user input is received prior to navigation along the route being initiated (and/or while navigation along the route is not occurring—for example, before the electronic device receives input to start the navigation along the route), such as is the case in FIG. 6E) and in accordance with a determination that the second destination is being added to the route as a destination located immediately after the first destination in the route (e.g., if the route includes user-provided stops or destinations B, C and D, where the route is from A (the beginning location of the route) to B to C to D, and if the second destination to be added is between C and D, then the second destination would be located immediately after C in the route; in some embodiments, the second destination is located immediately after the first destination in the route if no other user-provided (or otherwise) destinations exist in the route between the first destination and the to-be-added second destination), the electronic device initiates (702e) the search for the second destination based on the second user input, wherein the search is centered on a geographic area that includes the first destination in the route, such as shown in FIG. 6F as the representation of the map is centered on indication 612 (e.g., and the selected geographic area is independent of the locations of other destinations included in the route). For instance, if the electronic device has not begun navigation directions to the user's work location, and the second destination is being added immediately after the user's work location in the route, the electronic device will optionally center the search for coffee shops around the user's work location. In some embodiments, the results of the search include results corresponding to the search (e.g., that match the search request) that are located within the geographic area, but not results corresponding to the search that are located outside of the geographic area. In some embodiments, the beginning location of the route is not included in the geographic area. In some embodiments, destinations included in the route other than the first destination and the potential second destination are not included in the geographic area. In some embodiments, the geographic area is an area that is centered on the first destination, and extends radially from the first destination by an amount or a predetermined amount, such as 0.1, 0.3, 0.5, 1, 3, 5, 10, 20, 30, 50 or 100 km. In some embodiments, the geographic area includes the beginning location of the route and/or destinations included in the route other than the first destination and the potential second destination if those locations/destinations are within the above-described radial extension from the first destination. Centering a search for a second destination around the first destination that is immediately prior to the second destination automatically focuses the search on the location most likely to be relevant for the search and provides the user with the closest options to the first destination, thereby reducing the need for subsequent inputs for recentering the search on different geographic areas.

In some embodiments, in response to detecting the second user input, in accordance with a determination that the second user input is received while navigation along the route is in progress, the electronic device initiates the search for the second destination based on the second user input, wherein the search is centered on a geographical area that includes a current location of the electronic device on the route, such as shown in FIG. 6V as the representation of the map is centered around indication 606 (e.g., and the selected geographic area is independent of the locations of any destinations included in the route, and optionally does not include the locations of any destinations included in the route—though the selected geographic area optionally does include the locations of one or more destinations included in the route if they fall within the geographic area including the current location of the electronic device). For instance, if the electronic device has begun presenting navigation directions to the user's work location, and the second destination is being added immediately after the user's work location in the route, the electronic device will optionally center the search for coffee shops around the electronic device's current location (e.g., rather than the user's work location). In some embodiments, the results of the search include results corresponding to the search (e.g., that matches the search request) that are located within the geographic area, but not results corresponding to the search that are located outside of the geographic area. In some embodiments, the beginning location of the route is not included in the geographic area. In some embodiments, the first destination is not included in the geographic area. In some embodiments, the geographic area is an area that is centered on the current location of the electronic device, and extends radially from the current location by an amount or a predetermined amount, such as 0.1, 0.3, 0.5, 1, 3, 5, 10, 20, 30, 50 or 100 km. In some embodiments, the geographic area includes destinations included in the route other than the first destination and the potential second destination if those locations/destinations are within the above-described radial extension from the current location of the electronic device. Centering a search for a second destination around the current location of the electronic device automatically focuses the search on the location most likely to be relevant for the search and provides the user with the closest options to the current location, thereby reducing the need for subsequent inputs for recentering the search on different geographic areas.

In some embodiments, in response to detecting the second user input, in accordance with a determination that the second user input is received prior to navigation along the route being initiated, and in accordance with a determination that the second destination is being added to the route as a destination located immediately after a third destination, different from the first destination, the electronic device initiates the search for the second destination based on the second user input (e.g., into 634), wherein the search is centered on a geographic area that includes the third destination in the route, such as shown in FIG. 6E in which search field 634 is searched after Stop 1 and thus, the search in FIG. 6F is centered around the location of Stop 1 (e.g., and the selected geographic area is independent of the locations of any other destinations included in the route and/or the current location of the electronic device). In some embodiments, if the electronic device detects that the second destination is added immediately after a third destination, the electronic device will optionally center the search for the second destination around the third destination. In some embodiments, the results of the search include results corresponding to the search (e.g., that match the search request) that are located within the geographic area, but not results corresponding to the search that are located outside of the geographic area. Centering a search for a second destination around the third destination that is immediately prior to the second destination automatically focuses the search on the location most likely to be relevant for the search and provides the user with the closest options to the third destination, thereby reducing the need for subsequent inputs for recentering the search on different geographic areas.

In some embodiments, the search is centered on the geographic area that includes the first destination in the route in accordance with the determination that the second user input is received prior to navigation along the route being initiated, such as shown in FIG. 6F. In some embodiments, in accordance with the determination that the second destination is being added to the route as a destination located immediately after the first destination in the route, such as the addition of Stop 2 in FIG. 6CC, after initiating the search centered on the geographic area including the first destination in the route and while searching for the second destination based on the second user input, the electronic device detects, via the one or more input devices, a third user input corresponding to a request to center the search on a second geographic area, different from the geographic area that includes the first destination in the route, such as the movement of contact 603 in FIG. 6CC. For instance, the user wants to search in a location that is in a different location on the map. For example, the user wants to look at restaurants that are in a different county to plan for a later trip. In some embodiments, the third user input is a panning input (e.g., a swipe input) directed to the map to change the displayed portion of the map to be the second geographic area rather than the first geographic area.

In some embodiments, in response to detecting the third user input, the electronic device initiates a second search for the second destination based on the second user input, wherein the second search is centered on the second geographic area, such as the recentering of the search in FIG. 6DD (e.g., and the selected second geographic area is independent of the locations of any other destinations included in the route and/or the current location of the electronic device). In some embodiments, the electronic device will center the search for the second destination on the second geographic area such that the results of the search include results corresponding to the search (e.g., that match the search request) that are located within the second geographic area, but not results corresponding to the search that are located outside of the second geographic area. Centering a search for a second destination around a second geographic area based on the second user input focuses the search on the user desired location and provides the user with the closest options to the second geographic area, thereby reducing the need for subsequent inputs for correcting searches in areas not desired by the user.

In some embodiments, the search for the second destination includes displaying, via the display generation component, one or more search results corresponding to the second user input, such as shown in FIG. 6V. In some embodiments, in accordance with a determination that the one or more criteria are satisfied, such as shown in FIG. 6V as navigation has begun (e.g., including a criterion that is satisfied when the electronic device has started providing navigation directions for the route), the one or more search results are displayed with respective indications of additional time that would be added to the route if the corresponding destinations are added as the second destination to the route, such as the indications of the additional time for adding the locations described in search results 660-1 and/or 660-2. In some embodiments, and while the navigation is in progress, the respective indications are displayed within a user interface of the route configuration user interface. In some embodiments, the respective indications indicate an amount of additional time (e.g., 5 minutes, 10 minutes, 15 minutes, 30 minutes, 1 hour, or 2 hours) that would be added to the total travel time for the route if the corresponding destinations are added to the route. Displaying indications of additional time for potential additional stops provides the user with details to make informed additions to the route, thereby reducing erroneous addition of stops to the route and the need for subsequent inputs to correct for such errors.

In some embodiments, the one or more criteria include a criterion that is satisfied when the second user input is received while navigation along the route is in progress (e.g., and not satisfied when navigation along the route has not started and/or is not in progress), for instance as shown in FIG. 6V.

In some embodiments, the search for the second destination includes in accordance with a determination that the one or more criteria are not satisfied, for instance as shown in FIG. 6F as navigation has not yet begun, the one or more search results are not displayed with the respective indications of additional time that would be added to the route if the corresponding destinations are added as the second destination to the route, such as shown in FIG. 6F as search results 638-1 and 638-2 do not include the additional time if the results were added to the route. In some embodiments, and while the navigation is not in progress (e.g., in a pre-navigation route planning user interface), the respective indications are not displayed in the user interface of the route configuration user interface. Instead, the search results corresponding to the second input are optionally displayed without indications of how much additional time would be added to the total travel time for the route if the search results were added to the route as additional stops/destinations. Not displaying indications of additional time for potential additional stops avoids providing the user with additional unnecessary information, thereby simplifying the route planning procedure and avoiding consuming user interface area and processing resources.

In some embodiments, the electronic device receives, via the one or more input devices, an indication that the route has been modified at a second electronic device that is different from the electronic device, for instance as shown in suggested route 694 of FIG. 6GG. In some embodiments, the second electronic device is an electronic device, different from the electronic device, that shares an account with the electronic device (e.g., the electronic device and the second electronic device are both logged into the same user profile and/or account). In some embodiments, the indication is received from the second electronic device. In some embodiments, the indication is received from a server that is in communication with the electronic device and the second electronic device.

In some embodiments, after (e.g., in response to) receiving the indication, the electronic device updates the route at the electronic device, for instance as shown in user interface element 608 of FIG. 6HH (e.g., displaying the updated route, or a selectable representation of the updated route that is selectable to cause display of the updated route, at the electronic device in response to an input to display the maps application). In some embodiments, if the route is updated at the second electronic device to include an additional stop, the route is updated at the electronic device to also include the additional stop. Updating and/or synchronizing the route across electronic devices that are associated with each other ensures that the route is up-to-date for a user, thereby reducing the need for subsequent inputs for manually updating the route.

In some embodiments, the modification of the route at the second electronic device includes addition of a respective destination to the route, and updating the route at the electronic device includes updating the route to include the respective destination, such as shown in FIG. 6HH as Stop 3 has been added to the previous route shown in user interface element 608 of FIG. 6FF. In some embodiments, if the route is updated at the second electronic device to include additional stops and/or an updated destination, such as in one or more of the manners described herein with respect to the electronic device, the route is updated at the electronic device. Updating and/or synchronizing the route across electronic devices that are associated with each other ensures that the route is up-to-date for a user, thereby reducing the need for subsequent inputs for manually updating the route.

In some embodiments, while navigating along the route and displaying the route that includes the first destination and the second destination located immediately after the first destination, the electronic device detects that the location of the electronic device is within a threshold distance of the first destination, such as shown in FIG. 6M as indication 606 is approaching indication 644. In some embodiments, the threshold distance is a distance that is within 0.1, 0.3, 0.5, 1, 3, 5, 10, 20, 30, 50 or 100 km of the first destination.

In some embodiments, in response to detecting that the location of the electronic device is within the threshold distance of the first destination, the electronic device initiates a process to pause the navigation along the route prior to initiating navigation along the route from the first destination to the second destination, such as shown via contact 603 in FIG. 6M. In some embodiments, and if the location of the electronic device is approaching or arrived at the first destination, and there is at least an additional stop along the route, the electronic device pauses the navigation along the route. In some embodiments, the electronic device resumes the navigation along the route following the pause and in response to a user input and/or appropriate movement of the electronic device along the route. Pausing the navigation along the route optionally includes ceasing to display or otherwise provide instructions for performing the next maneuver (e.g., walking, driving, bicycling and/or transit maneuver) on the route. Pausing the navigation at a first stop along the route prior to moving to the next stop ensures that erroneous continuation of the route is avoided, thereby reducing the need for inputs to reverse the erroneous continuation of the route.

In some embodiments, initiating the process to pause the navigation along the route includes displaying a first selectable option (e.g., 648-1) that is selectable to pause the navigation along the route, and a second selectable option (e.g., 648-2) that is selectable to initiate the navigation along the route from the first destination to the second destination without pausing the navigation along the route, such as shown via interface element 648 in FIG. 6M. In some embodiments, selection of the first user selectable option pauses navigation along the route. In some embodiments, navigation along the route is resumed in response to a user input selecting the second selectable option and/or a movement of the electronic device along the route. Pausing or continuing the navigation at a first stop along the route based on user input ensures that erroneous pausing or continuation of the route is avoided, thereby reducing the need for inputs to reverse the erroneous continuation or pausing of the route

In some embodiments, initiating the process to pause the navigation along the route includes selectively pausing the navigation along the route automatically, without user input to pause the navigation along the route, such as shown via indication 652 in FIG. 6P. For example, the electronic device optionally pauses navigation along the route without detecting a user input selecting a selectable option for pausing the navigation and/or displaying a selectable option for pausing the navigation. In some embodiments, the electronic device automatically pauses the navigation along the route based on one or more of the factors described with reference to method 700. In some embodiments, if one or more of the below factors are not satisfied, the electronic device does not automatically pause the navigation along the route, and instead continues navigation along the route to the next destination in the route. Automatically pausing the navigation along the route reduces the needs for inputs for pausing the navigation.

In some embodiments, selectively pausing the navigation along the route automatically is based on one or more of a type of destination of the first destination, such as that the destination is a school as shown in FIG. 6M. For instance, if the type of destination is a destination where a user would typically pause for a period of time (e.g., more than 1, 3, 5, 10, 20, 30, 60 or 120 minutes) before moving to the next destination, the electronic device will automatically pause the navigation. In some embodiments, such a destination is a restaurant or coffee shop, a store or shop, a gas station, a park, or a workplace. Alternatively, if the type of destination is a destination where a user would typically not pause for a period of time before moving to the next destination, the electronic device will not automatically pause the navigation. In some embodiments, such a destination is a pick-up destination such as a school.

In some embodiments, selectively pausing the navigation along the route automatically is based on one or more of a location of the first destination, such the destination being a coffee shop at which the electronic device typically pauses, such as indication 642. For instance, if the location of the first destination is a location where a user has historically stopped and/or has historically paused navigation, the electronic device will optionally automatically pause the navigation when reaching the location of the first destination. Alternatively, if the location of the first destination is a location at which the user has not historically stopped and/or has not historically paused navigation, the electronic device will optionally not automatically pause the navigation. Automatically pausing the navigation along the route reduces the needs for inputs for pausing the navigation.

In some embodiments, initiating the search for the second destination based on the second user input includes that the electronic device concurrently displays, via the display generation component, one or more list search results corresponding to the second user input, such as search results 638-1 and 638-2 in FIG. 6F. In some embodiments, the list search results include one or more of the name of the search results, the image of the search results, the rating of the search results, the type of the search results, the open or closed status of the search results, the location (e.g., city/state) of the search results, and/or the cost associated with the search results (e.g., a typical cost of dining at a restaurant search result). In some embodiments, the search results in the list of search results are selectable to display additional information associated with the search results, such as a rating of the search result, a menu of the search result, additional photos associated with the search result, contact information associated with the search result, ratings of the search result, highlights of the search result, an address of the search result, and/or hours of operation of the search result. In some embodiments, the one or more list search results are displayed within a bottom portion of the (route configuration) user interface. The one or more list search results optionally include an indication of an amount of additional time (e.g., 5 minutes, 10 minutes, 15 minutes, 30 minutes, 1 hour, or 2 hours) that would be added to the route if the corresponding search results were added to the route.

In some embodiments, initiating the search for the second destination based on the second user input includes that the electronic device concurrently displays, via the display generation component one or more representations of the one or more list search results displayed on a virtual map, such as visual representations 640-1 and 640-2 in FIG. 6F (e.g., a representation of a map of a geographic area of the search). For instance, the one or more representations of the one or more list search results are displayed within a top portion of the (route configuration) user interface that displays the virtual map. In some embodiments, the one or more representations of the one or more list search results are displayed at corresponding locations on the virtual map that correspond to the physical locations of the one or more search results. In some embodiments, the one or more representations include an icon, a graphic, or an image that corresponds to the one or more search results. In some embodiments, the one or more representations of the search results displayed on the virtual map are selectable to display the same additional information noted above. Displaying search results in various ways provides the user with multiple ways to view or interact with the search results, thereby avoiding errors in interaction with the electronic device.

In some embodiments, initiating the search for the second destination based on the second user input includes that the electronic device displays, via the display generation component, one or more list search results corresponding to the second user input including a first list search result and a second list search result, such as shown in FIG. 6V (e.g., having one or more characteristics of the list search results described with reference to method 700).

In some embodiments, the first list search result is displayed with a first user selectable option that is selectable to initiate a process to add the first list search result (but not the second list search result) as a destination to the route, such as selecting search result 638-1 in FIG. 6F (at a respective position in the route); In some embodiments, selection of the first user selectable option adds the first list search result as a second destination on the route such that the first list search result is incorporated into the route as an additional destination. The location in the route at which the first list search result is incorporated is optionally based on the location in the route associated with the initial search corresponding to the second input, and is optionally not controlled or based on interaction with the first user selectable option.

In some embodiments, the second list search result is displayed with a second user selectable option that is selectable to initiate a process to add the second list search result (but not the first list search result) as a destination to the route, such as selecting search result 638-2 in FIG. 6F (at the respective position in the route). In some embodiments, selection of the second user selectable option adds the second list search result as a second destination on the route such that the second list search result is now incorporated into the route as an additional destination. The location in the route at which the second list search result is incorporated is optionally based on the location in the route associated with the initial search corresponding to the second input, and is optionally not controlled or based on interaction with the second user selectable option. Providing add buttons with the one or more list search results provides the user with a quick and easy way to add list search results to the route, thereby reducing the number of inputs needed to add destinations to the route.

In some embodiments, initiating the search for the second destination based on the second user input includes that the electronic device displays, via the display generation component, one or more representations of one or more search results corresponding to the second user input displayed on a representation of a map, such as in FIG. 6V (e.g., having one or more characteristics of the representations of search results displayed on a virtual map as described with reference to method 700).

In some embodiments, while displaying the one or more representations of the one or more search results corresponding to the second user input displayed on the representation of the map, the electronic device receives, via the one or more input devices, a third user input corresponding to selection of a first representation of a first search result of the one or more representations of the one or more search results, such as if electronic device received an input to visual representation 640-1 in FIG. 6F. In some embodiments, the third user input includes a tap, a click, a pinch or other input directed to the first representation of the first search result.

In some embodiments, in response to receiving the third user input, the electronic device displays, via the display generation component, a user interface corresponding to the first search result, such as shown in user interface element 608 of FIG. 6F (e.g., a user interface that includes information associated with the first search result that was not displayed in the user interface prior to receiving the third user input). In some embodiments, the user interface corresponding to the first search result is displayed concurrently with and/or overlaid on the representation of the map in the user interface. In some embodiments, the user interface corresponding to the first search result includes a name of the first search result, an amount of time that would be added to the total travel time for the route if the first search result is added, a type of destination of the first search result, and/or an indication of whether the first search result is open or closed, optionally in addition or alternatively to details of search results described with reference to method 700. In some embodiments, the user interface corresponding to the first search result includes a user selectable option (e.g., 638-1) that is selectable to initiate a process to add the first search result as a destination to the route, such as contact 603 in FIG. 6F. In some embodiments, selection of the user selectable option adds the first search result to the route as an additional destination. The location in the route at which the first search result is incorporated is optionally based on the location in the route associated with the initial search corresponding to the second input, and is optionally not controlled or based on interaction with the user selectable option. Providing the ability to add a search result to the route from a user interface corresponding to the search result avoids erroneous addition of destinations to the route (e.g., because the user interface corresponding to the search result optionally includes additional information about the search result that helps the user determine whether the search result should be added to the route).

In some embodiments, the electronic device displays, via the display generation component in a map browsing user interface, one or more suggested destinations for a navigation route, such as representations 605a-605e in FIG. 6A, based at least in part on one or more prior routes navigated by the electronic device, such as if the electronic device previously navigated to a location associated with representation 605a. For instance, the one or more suggested destinations are optionally those previously navigated by the electronic device within a threshold of time (e.g., 1 day, 5 days, 15 days, 30 days, 90 days, or 180 days) of a current time.

In some embodiments, the electronic device displays, via the display generation component in a map browsing user interface, one or more suggested destinations for a navigation route based at least in part on one or more calendar events accessible on the electronic device, such as if electronic device detected a calendar event to a location associated with representation 605d in FIG. 6A. For instance, the one or more suggested destinations are optionally to a location included in or associated with one or more calendar entries in a calendar application of the electronic device.

In some embodiments, the electronic device displays, via the display generation component in a map browsing user interface, one or more suggested destinations for a navigation route based at least in part on one or more recent searches performed on the electronic device, such as if electronic device detected a prior search to a location associated with representation 605c in FIG. 6A. For instance, the one or more suggested destinations are optionally to a location previously searched (within the maps application) by the electronic device within a threshold of time (e.g., 1 day, 5 days, 15 days, 30 days, 90 days, or 180 days) of a current time.

In some embodiments, the electronic device displays, via the display generation component in a map browsing user interface, one or more suggested destinations for a navigation route based at least in part on one or more events in a messaging application of the electronic device, such as if electronic device detected an event associated with a location associated with representation 605e in FIG. 6A. For instance, the one or more suggested destinations are optionally to a location mentioned in a messaging conversation, or a location of an event mentioned in a messaging conversation, in a messaging application of the electronic device. In some embodiments, the one or more suggested destinations are selectable to initiate respective processes for providing navigation directions from the current location of the electronic device to the selected suggested destination (e.g., in one or more of the manners described herein). Providing suggested destinations to a user provides a shortcut for selection of a destination, thereby reducing the number of inputs needed for choosing a destination for navigation directions.

In some embodiments, while navigating along the route, the electronic device receives, via the one or more user input, a third user input corresponding to a request to display a navigation tray that includes one or more selectable options for interacting with the route, such as contact 603 in FIG. 6R. For example, while navigating along the route, the electronic device displays, along a bottom portion of the user interface, a navigation user interface element that includes an estimated time of arrival for the entire route, an amount of time left in the route, and/or an amount of distance left in the route. The navigation user interface element optionally also includes a respective selectable option that is selectable to expand the navigation user interface element into the navigation tray, as will be described below. In some embodiments, the third user input includes selection of the respective selectable option, such as an input that includes a tap, a click, a pinch or other input directed to the respective selectable option.

In some embodiments, in response to receiving the third user input, the electronic device displays, via the display generation component, the navigation tray, such as shown in user interface element 608 in FIG. 6S. In some embodiments, the navigation tray (e.g., 608) includes representations of the destinations included in the route, including a first representation of the first destination and a second representation of the second destination, such as To and From shown in FIG. 6S. In some embodiments, the first representation of the first destination and the second representation of the second destination are displayed in the navigation tray as shapes, pictures, and/or text that identify the destinations. In some embodiments, the navigation tray includes an indication of the current location of the electronic device, as well as an indication of additional destinations in the route.

In some embodiments, the navigation tray (e.g., 608) includes a first indication of an estimated time for reaching the first destination displayed in association with the first representation, such as the 4:45 arrival time shown in FIG. 6S. In some embodiments, the first indication is displayed next to the representation of the first destination within the navigation tray. In some embodiments, the estimated time is displayed in minutes or hours, depending on the estimated time. In some embodiments, the estimated time is an estimated time to reach the first destination from the current location of the electronic device if the electronic device follows the navigation route to the first destination. In some embodiments, the estimated time is an estimated time of arrival (e.g., a wall clock time) at the first destination rather than an indication of a duration of time.

In some embodiments, the navigation tray (e.g., 608) includes a second indication of an estimated time for reaching the second destination displayed in association with the second representation, such as if another destination was shown in FIG. 6S along with the arrival time. In some embodiments, the second indication is displayed next to the representations of the second destination within the navigation tray. In some embodiments, the estimated time is displayed in minutes or hours, depending on the estimated time. In some embodiments, the estimated time is an estimated time to reach the second destination from the current location of the electronic device if the electronic device follows the navigation route to the second destination (and optionally including passing through the first destination on the way). In some embodiments, the estimated time is an estimated time of arrival (e.g., a wall clock time) at the second destination rather than an indication of a duration of time.

In some embodiments, the navigation tray includes a first selectable option that is selectable to remove the first destination from the route that is displayed in association with the first representation, such as first selectable option 654 shown in FIG. 6S. In some embodiments, the first selectable option is a displayed as text, a shape, or other equivalent indication. In some embodiments, selection of the first selectable option removes the first destination from the route.

In some embodiments, the navigation tray includes a second selectable option that is selectable to remove the second destination from the route that is displayed in association with the second representation, such as second selectable option 693 as shown in FIG. 6HH. In some embodiments, the second selectable option is a displayed as text, a shape, or other equivalent indication. In some embodiments, selection of the second selectable option removes the second destination from the route. In some embodiments, the navigation tray additional includes a selectable option to add a destination to the route, a selectable option to share an estimated time of arrival and/or the route with other users, a selectable option to report an incident along the route, a selectable option to end the route, and/or selectable options to move destinations in the route to different points in the route. Providing a navigation tray with options to view and/or modify the destinations in the route allows the user to easily view and manipulate the route, thereby reducing the number of inputs needed to interact with the route.

In some embodiments, after adding the first destination and the second destination to the route, and prior to navigation along the route being initiated, the electronic device displays, via the display generation component, one or more route lines corresponding to the route overlaid on a representation of a virtual map, such as suggested route (e.g., 694) shown in FIG. 6HH. In some embodiments, and when in route planning, the electronic device displays multiple route lines of the route when there is more than one destination included in the route. In some embodiments, the route lines are overlaid on the map at locations corresponding to the segments of the navigation route.

In some embodiments, in accordance with a determination by the electronic device that a current zoom level of the virtual map is a first zoom level, such as shown in FIG. 6HH. In some embodiments, the virtual map is manipulable such that the user can view the virtual map at different zoomed in levels (e.g., 10%, 30%, 50%, 80%, or 100% zoom levels). For instance, the current zoom level of the virtual map is optionally a first zoom level of 80%.

In some embodiments, the electronic device displays the virtual map with a first route line (e.g., from indication 606 to indication 696) from a current location of the electronic device to the first destination and a second route line from the first destination to the second destination, such as shown from indication 606 to indication 696 and then from indication 696 to indication 697 in FIG. 6HH. For instance, if the route is from the Destination A (e.g., current location) to Destination C with a stop at Destination B in between Destination A and Destination C, then the electronic device will display a first route line from Destination A to Destination B on the map, and a separate second route line from Destination B to Destination C on the map.

In some embodiments, the electronic device displays the first route line (e.g., from indication 606 to indication 696) in association with a first visual indication of an estimated length of the route from the current location of the electronic device to the first destination, such as shown in 8 min of FIG. 6HH. In some embodiments, and when the electronic device is at the first zoom level of 80% on the virtual map, the electronic device will display the estimated length of the route from Destination A to Destination B. In some embodiments, the estimated length is an estimated time duration of the route from Destination A to Destination B. In some embodiments, the estimated length is a distance of the route from Destination A to Destination B. In some embodiments, the estimated length is a time duration and a distance.

In some embodiments, the electronic device displays the second route line in association with a second visual indication of an estimated length of the route from the first destination to the second destination, such as shown in 2 min of FIG. 6HH. In some embodiments, and when the electronic device is at the first zoom level of 80% on the virtual map, the electronic device will separately display the estimated length of the route from Destination B to Destination C. In some embodiments, the estimated length is an estimated time duration of the route from Destination B to Destination C. In some embodiments, the estimated length is a distance of the route from Destination B to Destination C. In some embodiments, the estimated length is a time duration and a distance.

In some embodiments, in accordance with a determination by the electronic device that the current zoom level of the map is a second zoom level, less than the first zoom level, such as shown in FIG. 6II (e.g., the current zoom level of the virtual map is optionally a second zoom level of 20% (e.g., further zoomed out from the map than the first zoom level, such that the geographic area included in the map is larger than at the first zoom level). In some embodiments, the first zoom level is greater than a zoom threshold (e.g., a zoom threshold of 5, 10, 20, 50, 75 or 90%), and the second zoom level is less than the zoom threshold. In some embodiments, whenever the current zoom level is greater than the zoom threshold, the electronic device displays the separate route lines as described above. In some embodiments, whenever the current zoom level is less than the zoom threshold, the electronic device displays a combined and/or single route line, as described below. In some embodiments, the zoom threshold is greater the shorter the length of the route and/or the length of segments of the route, and the zoom threshold is less the longer the length of the route and/or the length of segments of the route), the electronic device displays the representation of the map in FIG. 6HH with a third route line (e.g., from indication 606 to indication 698) from a current location of the electronic device to the second destination, such as shown in FIG. 6II. For instance, if the route is from the Destination A (e.g., current location) to Destination C with a stop at Destination B in between Destination A and Destination C, then the electronic device will display a single, combined route line from Destination A to Destination C (optionally passing through Destination B), rather than displaying separate route lines for the segments of the route from Destination A to Destination B, and from Destination B to Destination C.

In some embodiments, the electronic device displays the third route line in association with a third visual indication of an estimated length of the route from the current location of the electronic device to the second destination, such as shown as 25 min in FIG. 6II. In some embodiments, the electronic device will display the single, combined estimated length of the route from Destination A to Destination C, rather than displaying separate indications of estimated lengths for the segments of the route from Destination A to Destination B, and from Destination B to Destination C. In some embodiments, the estimated length is an estimated time duration of the route from Destination A to Destination C. In some embodiments, the estimated length is a distance of the route from Destination A to Destination C. In some embodiments, the estimated length is a time duration and a distance. Providing the user with the ability to view the estimated length of the entire route or segments of route based on zoom level reduces the number of inputs needed to display such information.

It should be understood that the particular order in which the operations in FIG. 7 has been described is merely exemplary and is not intended to indicate that the described order is the only order in which the operations could be performed. One of ordinary skill in the art would recognize various ways to reorder the operations described herein.

The operations in the information processing methods described above are, optionally, implemented by running one or more functional modules in an information processing apparatus such as general purpose processors (e.g., a as described with respect to FIGS. 1A-1B, 3, 5A-5H) or application specific chips. Further, the operations described above with reference to FIG. 7 is, optionally, implemented by components depicted in FIGS. 1A-1B. For example, detecting operation 702a, adding operation 702b, detecting operation 702c, and initiating operation 702e are, optionally, implemented by event sorter 170, event recognizer 180, and event handler 190. Event monitor 171 in event sorter 170 detects a contact on touch screen 504, and event dispatcher module 174 delivers the event information to application 136-1. A respective event recognizer 180 of application 136-1 compares the event information to respective event definitions 186, and determines whether a first contact at a first location on the touch screen corresponds to a predefined event or sub-event, such as selection of an object on a user interface. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

As described above, one aspect of the present technology is the gathering and use of data available from specific and legitimate sources to improve the ability for users to search for stops in multiple stop routes. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used to identify the location of the user. Further, other uses for personal information data that benefit the user are also contemplated by the present disclosure. For instance, health and fitness data may be used, in accordance with the user's preferences to provide insights into their general wellness, or may be used as positive feedback to individuals using technology to pursue wellness goals.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, such as in the case of advertisement delivery services, the present technology can be configured to allow users to select to “opt in” or “opt out” of participation in the collection of personal information data during registration for services or anytime thereafter. In another example, users can select not to provide personal data and/or device or object location data. In yet another example, users can select to limit the length of time personal data and/or device or object location data is maintained or entirely block the development of a baseline location profile. In addition to providing “opt in” and “opt out” options, the present disclosure contemplates providing notifications relating to the access or use of personal information. For instance, a user may be notified upon downloading an application that their personal information data and/or location data will be accessed and then reminded again just before personal information data is accessed by the application.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, location data and notifications can be delivered to users based on aggregated non-personal information data or a bare minimum amount of personal information.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

1. A method comprising:
at an electronic device in communication with a display generation component and one or more input devices:
while displaying, via the display generation component, a route configuration user interface, detecting, via the one or more input devices, a first user input corresponding to a request to add a first destination to a route;
in response to detecting the first user input, adding the first destination to the route;
while the first destination is included in the route, detecting, via the one or more input devices, a second user input corresponding to a request to search for a second destination to be added to the route; and
in response to detecting the second user input:
in accordance with a determination that the second user input is received prior to navigation along the route being initiated, and in accordance with a determination that the second destination is being added to the route as a destination located immediately after the first destination in the route, initiating the search for the second destination based on the second user input, wherein the search is centered on a geographic area that includes the first destination in the route.

2. The method of claim 1, the method further comprising:
in response to detecting the second user input:
in accordance with a determination that the second user input is received while navigation along the route is in progress, initiating the search for the second destination based on the second user input, wherein the search is centered on a geographical area that includes a current location of the electronic device on the route.

3. The method of claim 1, the method further comprising:
in response to detecting the second user input:
in accordance with a determination that the second user input is received prior to navigation along the route being initiated, and in accordance with a determination that the second destination is being added to the route as a destination located immediately after a third destination, different from the first destination, initiating the search for the second destination based on the second user input, wherein the search is centered on a geographic area that includes the third destination in the route.

4. The method of claim 1, wherein the search is centered on the geographic area that includes the first destination in the route in accordance with the determination that the second user input is received prior to navigation along the route being initiated, and in accordance with the determination that the second destination is being added to the route as a destination located immediately after the first destination in the route, the method further comprising:
after initiating the search centered on the geographic area including the first destination in the route and while searching for the second destination based on the second user input:
detecting, via the one or more input devices, a third user input corresponding to a request to center the search on a second geographic area, different from the geographic area that includes the first destination in the route; and
in response to detecting the third user input, initiating a second search for the second destination based on the second user input, wherein the second search is centered on the second geographic area.

5. The method of claim 1, wherein the search for the second destination includes:
displaying, via the display generation component, one or more search results corresponding to the second user input, wherein in accordance with a determination that one or more criteria are satisfied, the one or more search results are displayed with respective indications of additional time that would be added to the route if the corresponding destinations are added as the second destination to the route.

6. The method of claim 5, wherein the one or more criteria include a criterion that is satisfied when the second user input is received while navigation along the route is in progress, and the search for the second destination includes:
in accordance with a determination that the one or more criteria are not satisfied, the one or more search results are not displayed with the respective indications of additional time that would be added to the route if the corresponding destinations are added as the second destination to the route.

7. The method of claim 1, the method further comprising:
receiving, via the one or more input devices, an indication that the route has been modified at a second electronic device that is different from the electronic device; and
after receiving the indication, updating the route at the electronic device.

8. The method of claim 7, wherein the modification of the route at the second electronic device includes addition of a respective destination to the route, and updating the route at the electronic device includes updating the route to include the respective destination.

9. The method of claim 1, the method further comprising:
while navigating along the route and displaying the route that includes the first destination and the second destination located immediately after the first destination, detecting that the location of the electronic device is within a threshold distance of the first destination; and
in response to detecting that the location of the electronic device is within the threshold distance of the first destination, initiating a process to pause the navigation along the route prior to initiating navigation along the route from the first destination to the second destination.

10. The method of claim 9, wherein initiating the process to pause the navigation along the route includes displaying a first selectable option that is selectable to pause the navigation along the route, and a second selectable option that is selectable to initiate the navigation along the route from the first destination to the second destination without pausing the navigation along the route.

11. The method of claim 9, wherein initiating the process to pause the navigation along the route includes selectively pausing the navigation along the route automatically, without user input to pause the navigation along the route.

12. The method of claim 11, wherein selectively pausing the navigation along the route automatically is based on one or more of:
a type of destination of the first destination; or
a location of the first destination.

13. The method of claim 1, wherein initiating the search for the second destination based on the second user input includes:
concurrently displaying, via the display generation component:
one or more list search results corresponding to the second user input; and
one or more representations of the one or more list search results displayed on a virtual map.

14. The method of claim 1, wherein initiating the search for the second destination based on the second user input includes displaying, via the display generation component, one or more list search results corresponding to the second user input including a first list search result and a second list search result, wherein:
the first list search result is displayed with a first user selectable option that is selectable to initiate a process to add the first list search result as a destination to the route; and
the second list search result is displayed with a second user selectable option that is selectable to initiate a process to add the second list search result as a destination to the route.

15. The method of claim 1, wherein initiating the search for the second destination based on the second user input includes displaying, via the display generation component, one or more representations of one or more search results corresponding to the second user input displayed on a representation of a map, the method further comprising:
while displaying the one or more representations of the one or more search results corresponding to the second user input displayed on the representation of the map, receiving, via the one or more input devices, a third user input corresponding to selection of a first representation of a first search result of the one or more representations of the one or more search results; and
in response to receiving the third user input, displaying, via the display generation component, a user interface corresponding to the first search result, wherein the user interface corresponding to the first search result includes a user selectable option that is selectable to initiate a process to add the first search result as a destination to the route.

16. The method of claim 1, the method further comprising:
displaying, via the display generation component in a map browsing user interface, one or more suggested destinations for a navigation route based at least in part on:
one or more prior routes navigated by the electronic device;
one or more calendar events accessible on the electronic device;
one or more recent searches performed on the electronic device; or
one or more events in a messaging application of the electronic device.

17. The method of claim 1, the method further comprising:
while navigating along the route, receiving, via the one or more user input, a third user input corresponding to a request to display a navigation tray that includes one or more selectable options for interacting with the route; and
in response to receiving the third user input, displaying, via the display generation component, the navigation tray, wherein the navigation tray includes:
representations of the destinations included in the route, including a first representation of the first destination and a second representation of the second destination;
a first indication of an estimated time for reaching the first destination displayed in association with the first representation;
a second indication of an estimated time for reaching the second destination displayed in association with the second representation;
a first selectable option that is selectable to remove the first destination from the route that is displayed in association with the first representation; and
a second selectable option that is selectable to remove the second destination from the route that is displayed in association with the second representation.

18. The method of claim 1, the method further comprising:
after adding the first destination and the second destination to the route, and prior to navigation along the route being initiated, displaying, via the display generation component, one or more route lines corresponding to the route overlaid on a representation of a virtual map, wherein:
in accordance with a determination that a current zoom level of the virtual map is a first zoom level:
the virtual map is displayed with a first route line from a current location of the electronic device to the first destination and a second route line from the first destination to the second destination,
the first route line is displayed in association with a first visual indication of an estimated length of the route from the current location of the electronic device to the first destination, and
the second route line is displayed in association with a second visual indication of an estimated length of the route from the first destination to the second destination; and
in accordance with a determination that the current zoom level of the map is a second zoom level, less than the first zoom level:
the representation of the map is displayed with a third route line from a current location of the electronic device to the second destination, and
the third route line is displayed in association with a third visual indication of an estimated length of the route from the current location of the electronic device to the second destination.

19. An electronic device, comprising:
one or more processors;
memory; and
one or more programs, wherein the one or more programs are stored in the memory and configured to be executed by the one or more processors, the one or more programs including instructions for:
while displaying, via a display generation component, a route configuration user interface, detecting, via one or more input devices, a first user input corresponding to a request to add a first destination to a route;
in response to detecting the first user input, adding the first destination to the route;
while the first destination is included in the route, detecting, via the one or more input devices, a second user input corresponding to a request to search for a second destination to be added to the route; and
in response to detecting the second user input:
in accordance with a determination that the second user input is received prior to navigation along the route being initiated, and in accordance with a determination that the second destination is being added to the route as a destination located immediately after the first destination in the route, initiating the search for the second destination based on the second user input, wherein the search is centered on a geographic area that includes the first destination in the route.

20. A non-transitory computer readable storage medium storing one or more programs, the one or more programs comprising instructions, which when executed by one or more processors of an electronic device, cause the electronic device to perform a method comprising:
while displaying, via a display generation component, a route configuration user interface, detecting, via one or more input devices, a first user input corresponding to a request to add a first destination to a route;
in response to detecting the first user input, adding the first destination to the route;
while the first destination is included in the route, detecting, via the one or more input devices, a second user input corresponding to a request to search for a second destination to be added to the route; and
in response to detecting the second user input:
in accordance with a determination that the second user input is received prior to navigation along the route being initiated, and in accordance with a determination that the second destination is being added to the route as a destination located immediately after the first destination in the route, initiating the search for the second destination based on the second user input, wherein the search is centered on a geographic area that includes the first destination in the route.

21. (canceled)

22. (canceled)

23. (canceled)

24. (canceled)

25. (canceled)

26. (canceled)

27. (canceled)
